(19) United States
(12) Patent Application Publication
(10) Pub. No.: US 2014/0012539 A1
(43) Pub. Date: Jan. 9, 2014

(54) INFORMATION PROCESSING APPARATUS, CONGESTION DEGREE MAP GENERATING APPARATUS, INFORMATION PROCESSING METHOD, PROGRAM, AND RECORDING MEDIUM

(71) Applicant: Tomohisa Takaoka, Kanagawa (JP)

(72) Inventor: Tomohisa Takaoka, Kanagawa (JP)

(73) Assignee: SONY COPORATION, Minato-ku, Tokyo (JP)

(21) Appl. No.: 14/006,000

(22) PCT Filed: Feb. 21, 2012
(86) PCT No.: PCT/JP2012/054130

§ 371 Date: Sep. 18, 2013

(30) Foreign Application Priority Data
Mar. 31, 2011 (JP) 2011-078317

(51) Int. Cl. G01C 22/00

(52) U.S. Cl. CPC G01C 22/006
USPC 702/160

(57) ABSTRACT

Provided is an information processing apparatus including an acquisition unit configured to acquire a pitch of walking from oscillation detection data, and a congestion determination unit configured to determine a congestion degree based on a difference between the pitch acquired by the acquisition unit and a pitch during normal walking which is calculated based on the oscillation detection data of a past.

### TECHNICAL FIELD

The present disclosure relates to an information processing apparatus, a congestion degree map generating apparatus, an information processing method, a program, and a recording medium, and particularly relates to an information processing apparatus to determine a state of a user, a congestion degree map generating apparatus, an information processing method, a program, and a recording medium.

### BACKGROUND ART

It is important information whether or not an area surrounding a person is in a congestion state affect a behavior of the person. For example, Patent literature 1 discloses a service which counts the number of persons in an area on the basis of position information and analyzes a congestion degree on the basis of the number of the persons.

### CITATION LIST

### Patent Literature

Patent Literature 1: JP 2006-133903A

### SUMMARY OF INVENTION

### Technical Problem

However, the method disclosed in Patent Literature 1 above has not been able to grasp whether or not each person is affected by the congestion. In consideration of the above, it is preferable to determine that the congestion degree is high in a case where when the user is walking, the surrounding area thereof is congested and the user is affected by the congestion.

### Solution to Problem

According to an embodiment of the present disclosure, there is provided an information processing apparatus including an acquisition unit configured to acquire a pitch of walking from oscillation detection data, and a congestion determination unit configured to determine a congestion degree based on a difference between the pitch acquired by the acquisition unit and a pitch during normal walking which is calculated based on the oscillation detection data of a past.

Further, according to an embodiment of the present disclosure, there is provided a congestion degree map generating apparatus including an acquisition unit configured to acquire position information of a user who is determined to be in a congestion state based on a difference between a pitch of walking detected from oscillation detection data which is acquired by a plurality of terminal apparatuses and a pitch during normal walking calculated based on the oscillation detection data of a past, and a congestion degree map generating unit configured to generate a congestion degree map having a map superimposed with the position information acquired by the acquisition unit.

Further, according to an embodiment of the present disclosure, there is provided an information processing method including acquiring a pitch of walking from oscillation detection data, and determining a congestion degree based on a difference between the acquired pitch and a pitch during normal walking which is calculated based on the oscillation detection data of a past.

Further, according to an embodiment of the present disclosure, there is provided a program for causing a computer to function as an information processing apparatus, the information processing apparatus including an acquisition unit configured to acquire a pitch of walking from oscillation detection data, and a congestion determination unit configured to determine a congestion degree based on a difference between the pitch acquired by the acquisition unit and a pitch during normal walking which is calculated based on the oscillation detection data of a past.

Further, according to an embodiment of the present disclosure, there is provided a computer readable recording medium having a program recorded thereon, the program causing a computer to function as an information processing apparatus including an acquisition unit configured to acquire a pitch of walking from oscillation detection data, and a congestion determination unit configured to determine a congestion degree based on a difference between the pitch acquired by the acquisition unit and a pitch during normal walking which is calculated based on the oscillation detection data of a past.

### Advantageous Effects of Invention

According to the present disclosure described above, it is possible to determine that the congestion degree is high in a case where when the user is walking, the surrounding area thereof is congested and the user is affected by the congestion.

### BRIEF DESCRIPTION OF DRAWINGS

FIG. 1 is an illustration showing an overview of a congestion state determination method according to the present disclosure.

FIG. 2 is a graph showing an example of oscillation detection data at normal time.

FIG. 3 is a graph showing an example of oscillation detection data at congested time.

FIG. 4 is a functional configuration diagram of a terminal apparatus according to a first embodiment of the present disclosure.

FIG. 5 is a block diagram showing a configuration example of a position information acquisition unit in a terminal apparatus according to first to third embodiments of the present disclosure.

FIG. 6 is a hardware configuration diagram of the terminal apparatus according to the first to third embodiments of the present disclosure.

FIG. 7 is a graph view showing an example of oscillation detection data (detected by an acceleration sensor) at a normal time when the terminal apparatus is put in a pocket and carried around.

FIG. 8 is a graph view showing an example of oscillation detection data (detected by an acceleration sensor) at a normal time when the terminal apparatus is held by hand and carried around.

FIG. 9 is a graph view showing an example of oscillation detection data (detected by an acceleration sensor) at a congested time.

FIG. 10 is a graph view showing an example of oscillation detection data (detected by a gyro sensor) at a normal time when the terminal apparatus is placed on the waist.

FIG. 11 is a graph view showing an example of oscillation detection data (detected by a gyro sensor) at a normal time when the terminal apparatus is put in a pocket and carried around.

FIG. 12 is a graph view showing an example of oscillation detection data (detected by a gyro sensor) at a normal time when the terminal apparatus is held by hand and carried around.

FIG. 13 is a flowchart showing an example of a congestion determination process according to an embodiment of the present disclosure.

FIG. 14 is a flowchart showing another example of the congestion determination process according to the same embodiment.

FIG. 15 is a flowchart showing an operating process of the terminal apparatus according to the first embodiment of the present disclosure.

FIG. 16 is a configuration diagram of a congestion information generating system according to the second embodiment of the present disclosure.

FIG. 17 is a functional configuration diagram of a terminal apparatus according to the same embodiment.

FIG. 18 is a sequence diagram showing an example of an operating process of the congestion information generating system according to the same embodiment.

FIG. 19 is a sequence diagram showing another example of the operating process of the congestion information generating system according to the same embodiment.

FIG. 20 is a configuration diagram of a congestion information generating system according to the third embodiment of the present disclosure.

FIG. 21 is a functional configuration diagram of a congestion information generating system according to the same embodiment.

FIG. 22 is a sequence diagram showing an example of an operating process of the congestion information generating system according to the same embodiment.

FIG. 23 is an illustration showing an example of congestion information provided by the congestion information generating system according to the second and third embodiments of the present disclosure.

FIG. 24 is an illustration showing another example of the congestion information provided by the congestion information generating system according to the second and third embodiments of the present disclosure.

FIG. 25 is an illustration showing an example applying the congestion information provided by the congestion information generating system according to the second and third embodiments of the present disclosure.

FIG. 26 is an illustration showing an example of the congestion information provided by the congestion information generating system according to the second and third embodiments of the present disclosure.

FIG. 27 is an illustration showing an example applying the congestion information provided by the congestion information generating system according to the second and third embodiments of the present disclosure.

FIG. 28 is an illustration showing an example of the congestion information provided by the congestion information generating system according to the second and third embodiments of the present disclosure.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Hereinafter, description will be given in the order below.
1. Overview
2. First embodiment

2-1. Functional configuration example

2-2. Hardware configuration example

2-3. Oscillation detection data

2-4. Operating process example

2-5. Example of effect
3. Second embodiment (example of uploading congestion information to sever)

3-1. System configuration example

3-2. Functional configuration example of terminal apparatus

3-3. Operating process example

3-4. Example of effect
4. Third embodiment (example of performing congestion determination on sever side)

4-1. System configuration example

4-2. Functional configuration example

4-3. Operating process example

4-4. Example of effect
5. Application example

### 1. Overview

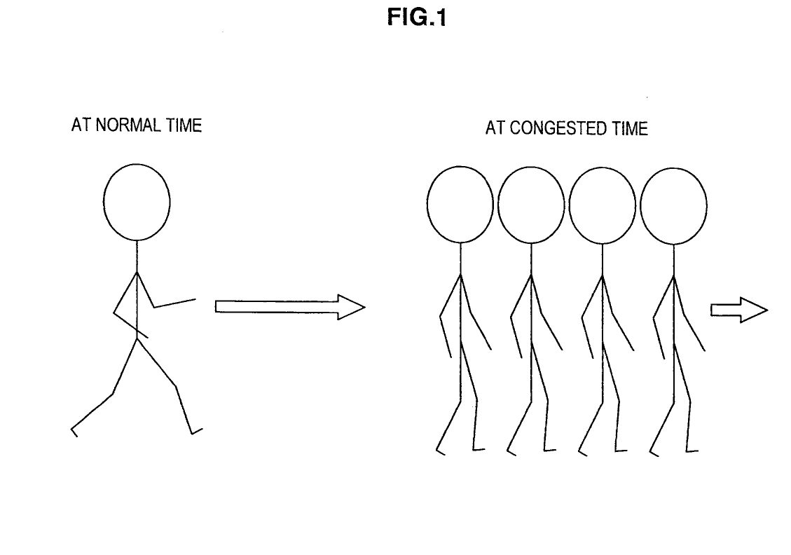

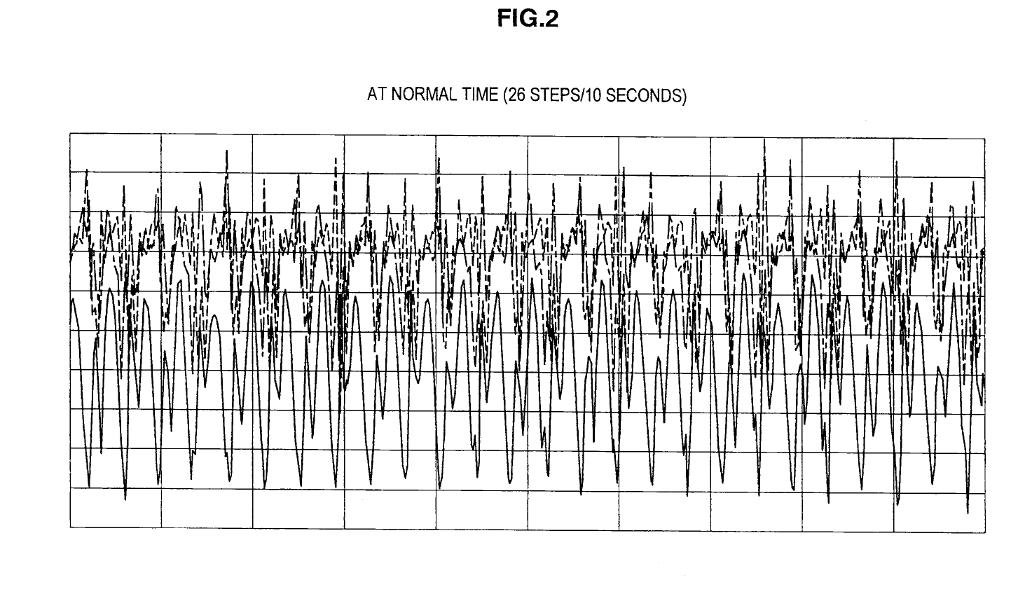

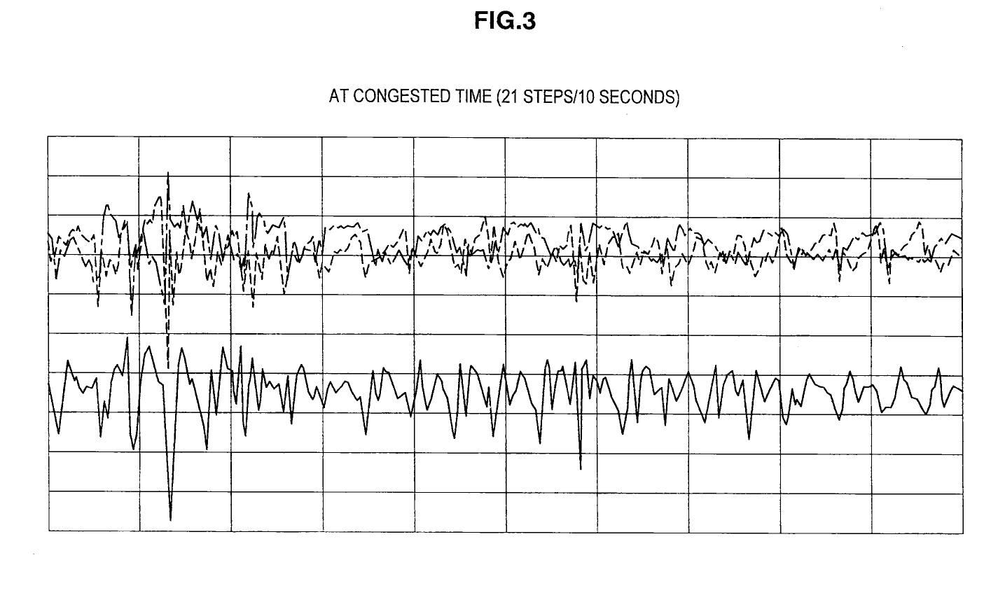

First, description will be given of an overview of a congestion state determination method according to an embodiment of the present disclosure described later with reference to FIG. 1 to FIG. 3. FIG. 1 is an illustration showing the overview of the congestion state determination method according to the present disclosure. FIG. 2 is a graph showing an example of oscillation detection data at normal time. FIG. 3 is a graph showing an example of oscillation detection data at congested time.

The congestion state determination method according to an embodiment of the present disclosure determines whether or not each user is in a congestion state on the basis of oscillation detection data acquired by a terminal apparatus the user carries. At this time, the congestion state refers to a state in which the user is actually affected by congestion and brought into a state of being hard to move.

In accordance to this definition, for example, even if a density of persons in a certain area is low, a person being waiting in a line generated in the area is in the congestion state, and a person only passing the line is not in the congestion state. According to the congestion state determination method of an embodiment of the present disclosure, difference between the both can be distinguished. For example. a method of determining the congestion state on the basis of a distribution of the number of persons in the area might determine the state is not congested simply if the number of persons is low in the area. For this reason, the persons waiting in a line and the persons passing the line are not distinguished from each other.

Additionally, if a state of each user is to be detected, for example, a moving velocity of the user may be considered to be used. However, if it is simply determined using the user's velocity that the state is congested because the velocity is being lowered, the state may be wrongly determined to be congested in the case of slowly moving by way of a moving walkway, an escalator or the like.

Therefore, the congestion state determination method according to an embodiment of the present disclosure determines whether or not the user is in the congestion state on the basis of the oscillation detection data acquired by a terminal apparatus the user carries. The oscillation detection data is acquired by a sensor (e.g., acceleration sensor, gyro sensor, and atmospheric pressure sensor) which is provided to the terminal apparatus and can detect oscillation.

As shown in FIG. 1, there is a difference in a user's pitch of walking between at normal time and at congested time. The pitch at congested time in normal time is lower than the pitch at normal time. An example of the oscillation detection data at this time is shown in FIG. 2 and FIG. 3. As can be seen from the comparison of FIG. 2 with FIG. 3, the user's pitch of walking appearing in a phase of the oscillation detection data is lower at congested time compared with that at normal time. Further, amplitude of the oscillation detection data is also different at normal time from at congested time. By use of this difference, description will be given of an embodiment of a congestion state determination apparatus for determining the congestion state according to the present disclosure.

Here, in the description and the drawings, a plurality of constituent elements having substantially the same functional configuration may be distinguished in some cases by attaching different alphabets to the same reference signs as suffixes. For example, a terminal apparatus 100 is distinguished as a terminal apparatus 100a, a terminal apparatus 100b, and a terminal apparatus 100c in each embodiment, However, if the plurality of constituent elements having substantially the same functional configuration are not necessary to be distinguished from each other, the same reference signs only are attached. For example, in the case where a terminal apparatus 100a, a terminal apparatus 100b, a terminal apparatus 100c and the like are not necessary to be distinguished from each other, it is simply referred to the terminal apparatus 100.

### 2. First Embodiment

### 2-1. Functional Configuration Example

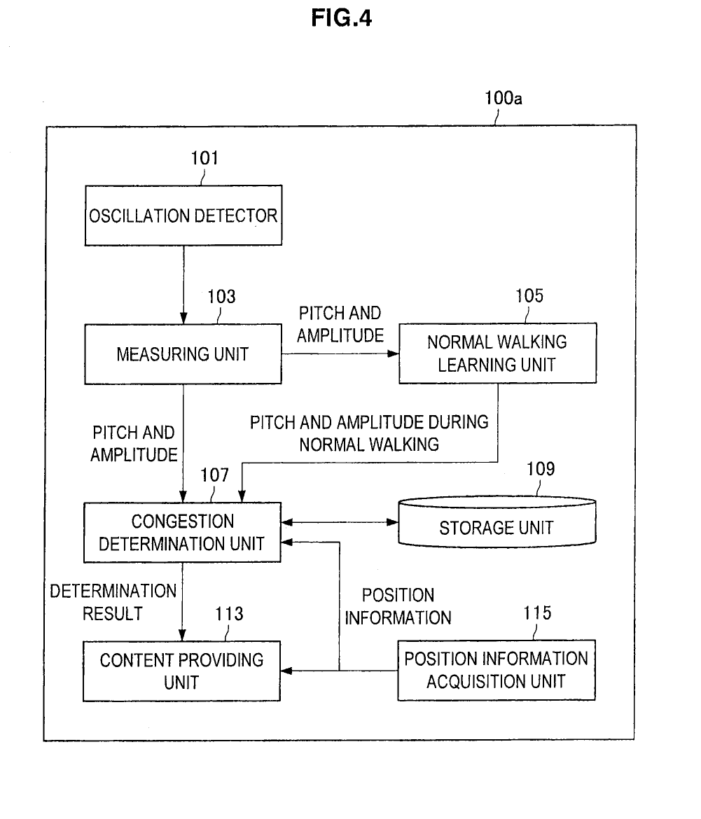

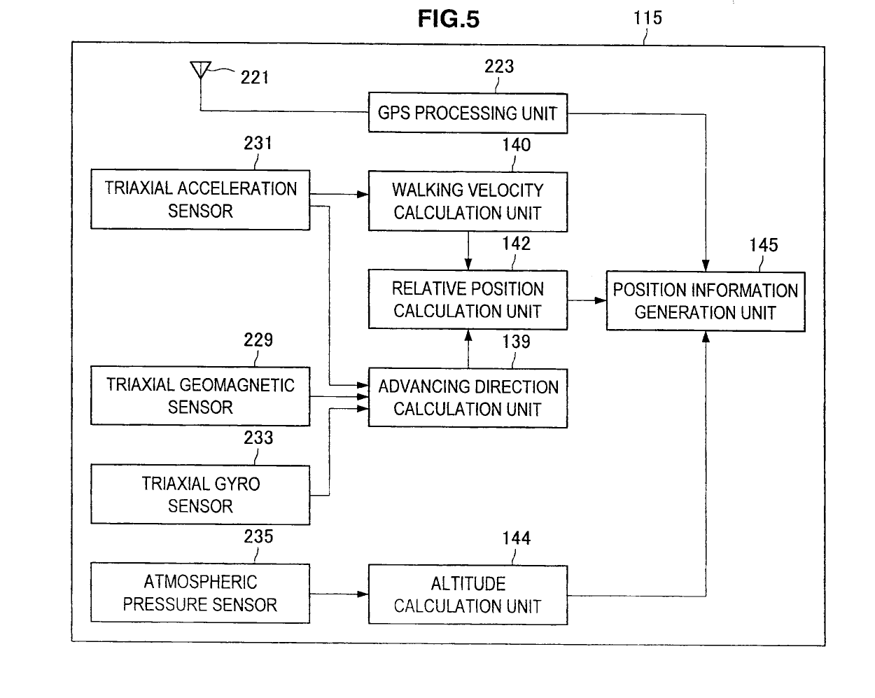

Here, description will be given of a configuration of a terminal apparatus 100a as an example of the congestion state determination apparatus according to the first embodiment of the present disclosure with reference to FIG. 4 and FIG. 5. FIG. 4 is a functional configuration diagram of a terminal apparatus according to the first embodiment of the present disclosure. FIG. 5 is a block diagram showing a configuration example of a position information acquisition unit in the terminal apparatus according to first to third embodiments of the present disclosure.

The terminal apparatus 100a is an example of an information processing apparatus that determines the state of congestion. The terminal apparatus 100a may be an information processing apparatus such as a mobile phone, a notebook personal computer (PC), a personal navigation device (PND), a portable music reproduction device, a portable image processing device, and a portable game machine. With reference to FIG. 4, the terminal apparatus 100a mainly includes an oscillation detector 101, a measuring unit 103, a normal walking learning unit 105, a congestion determination unit 107, a storage unit 109, a content providing unit 113, and a position information acquisition unit 115.

The oscillation detector 101 is a sensor that detects oscillation. For example, the oscillation detector 101 may be any one of an acceleration sensor, a gyro sensor and an atmospheric pressure sensor. The oscillation detector 101 can supply detected oscillation detection data to the measuring unit 103.

The measuring unit 103 has a function of measuring amplitude and pitch of the oscillation detection data acquired by the oscillation detector 101. It is to be noted that the measuring unit 103 is an example of an acquisition unit that acquires the amplitude and pitch of the oscillation detection data. Once the measuring unit 103 has measured amplitude and pitch of the oscillation detection data acquired by the oscillation detector 101, the measuring unit 103 can supply the measured amplitude and pitch to the normal walking learning unit 105 and the congestion determination unit 107.

The normal walking learning unit 105 has a function of learning the amplitude and pitch of the oscillation detection data during normal walking of the user of the terminal apparatus 100a. For example, the normal walking learning unit 105 can calculate average amplitude and pitch values of the oscillation detection data of the past, which was obtained when it was determined that the user was normally walking, and can thereby supply the amplitude and pitch values during normal walking to the congestion determination unit 107. Note that it is desirable that the oscillation detection data for use in this case is data of a vertical direction that tends to include an influence of walking.

The congestion determination unit 107 has a function to determine a congestion degree based on differences between the values of the amplitude and pitch of the oscillation detection data supplied from the measuring unit 103 and the values of the amplitude and pitch during normal walking which is calculated on the basis of the oscillation detection data of a past by the normal walking learning unit 105. The congestion determination unit 107 may supply a determination result to the content providing unit 113 if the content providing unit 113 has a configuration to select content to be supplied depending on the determination result. Here, this congestion determination unit 107 may store the determination result in the storage unit 109 inside the terminal apparatus 100a. At this time, the congestion determination unit 107, when the state is determined to be congested, for example, can associate a time of the determination with position information of the terminal apparatus 100a supplied from the position information acquisition unit 115 to be stored in the storage unit 109. Here, the congestion determination unit 107 can store a moving direction of the user included in the position information as a congestion orientation.

The storage unit 109 is a data storage device and may include a storage medium, a recording device that records data in a storage medium, a reading device that reads data from a storage medium, and a deleting device that deletes data recorded in a storage medium. Here, for example, a non-volatile memory such as a flash memory, a magnetoresistive random access memory (MRAM), a ferroelectric random access memory (FeRAM), a phase change random access memory (PRAM), or an electronically erasable and programmable read-only memory (EEPROM), or a magnetic recording medium such as a hard disk drive (HDD) may be used as the storage medium. For example, the storage unit 109 can store the date and time, when it has been determined to be in the congestion state, in association with the position information as described above. In addition, the storage unit 109 may store information on a duration of a state determined to be the congestion state.

The content providing unit 113 may has output functions such as a display unit and an audio output unit, for example, to provide the content to the user. Here, the content refers to a concept including audio data such as music, lecture, and radio program, video data such as cinema, television program, vide program, photograph, document, picture, and diagram, game and software, start up of application or push notification from application, and the like, for example. Here, the content providing unit 113 is also an example of a selection unit which selects the content on the basis of the congestion degree determined by the congestion determination unit 107. The content providing unit 113 may have a function to select the content to be provided to the user on the basis of the determination result by the congestion determination unit 107. For example, the content providing unit 113 may select content having an effect for reducing a stress on the user in the case where the user is determined in the congestion state. Additionally, the content providing unit 113 may also change a frequency of providing the user with the content depending on the congestion degree. For example, a function of the push notification is included which notifies the user of a recommendation for the user or an information arrival with an application. The user in the congestion state is likely to be more interested in the push notification compared to during normal walking. For this reason, when the state is determined to be congested, the frequency of the push notification may be set higher than at normal time. Particularly, the content used for so to speak “killing time” may be effectively provided to the user.

In addition, the content providing unit 113 may provide the user with the content selected on the basis of current position information of the terminal apparatus 100a. The content providing unit 115 may provide the user with the content concerning an area surrounding a current position when the state is determined to be congested by the congestion determination unit 107. For example, if the terminal apparatus 100a is detected being positioned in Shibuya by way of the current position information, the content providing unit 113 may provide the content concerning Shibuya to the user. Alternatively, the content providing unit 113 may, if a shop at the head of the queue that the user is waiting in line can be found out by way of the current position information, provide information concerning the relevant shop.

The position information acquisition unit 115 has a function of acquiring current position information of the terminal apparatus 100a. The position information acquisition unit 115 may have a function of acquiring, for example, position information based on positioning by global positioning system (GPS), position information based on Wi-Fi positioning, position information based on positioning by indoor messaging system (IMES), position information based on the location of a base station of a mobile phone, or relative position information based on a detection value of a sensor. Among these positioning functions, a plurality of functions may be possessed in combination. A description is now given of an example of the configuration of the position information acquisition unit 115 with reference to FIG. 5. FIG. 5 shows an example of the position information acquisition unit 115 having a function of GPS positioning and a function of relative position positioning with a sensor.

The position information acquisition unit 115 mainly includes a GPS antenna 221, a GPS processing unit 223, a triaxial geomagnetic sensor 229, a triaxial acceleration sensor 231, a triaxial gyro sensor 233, an advancing direction calculation unit 139, a walking velocity calculation unit 140, a relative position calculation unit 142, an atmospheric pressure sensor 235, an altitude calculation unit 144, and a position information generation unit 145.

The GPS antenna 221 is an example of an antenna that receives signals from GPS satellites. The GPS antenna 221 can receive GPS signals from a plurality of GPS satellites and input the received GPS signal into the GPS processing unit 221.

The GPS processing unit 223 has a function as a calculating unit that calculates position information based on the signals received from the GPS satellites. The GPS processing unit 223 calculates the current position information based on the plurality of GPS signals input from the GPS antenna 221 and outputs the calculated current position information of the terminal apparatus 200. Specifically, the GPS processing unit 223 calculates the position of each GPS satellite based on trajectory data of the GPS satellite and calculates the distance between each GPS satellite and the terminal apparatus 100 based on a time difference between transmission and reception times of the GPS signal. Then, the current three-dimensional position can be calculated based on the calculated position of each GPS satellite and the distance between each GPS satellite and the terminal apparatus 100. Here, the trajectory data of the GPS satellite may be included in the GPS signal. Furthermore, the trajectory data of the GPS satellite may be data which is acquired from an external server via a communication unit.

The triaxial geomagnetic sensor 229 is a sensor that detects acceleration as a voltage value. The triaxial geomagnetic sensor 229 detects each of geomagnetism data Mₓ in an X axis direction, geomagnetism data M_{y} in a Y axis direction, and geomagnetism data M_{z} in a Z axis direction. For example, the X axis may herein be defined as a longitudinal direction of a display screen of the terminal apparatus 100, the Y axis as a shorter side direction of the display screen, and the Z axis as a direction orthogonal to the X axis and the Y axis. The triaxial geomagnetic sensor 229 can supply detected geomagnetism data to the advancing direction calculation unit 139.

The triaxial acceleration sensor 231 is a sensor that detects acceleration as a voltage value. The triaxial acceleration sensor 231 may detect each of the acceleration αₓ in the X axis direction, the acceleration α_{z} in the Y axis direction, and the acceleration A_{Z} the Z axis direction. The triaxial acceleration sensor 231 can supply the detected acceleration data to the advancing direction calculation unit 139 and the walking velocity calculation unit 140.

The triaxial gyro sensor 233 is a sensor that detects velocity (angular velocity) having a variable rotation angle as a pressure value. The triaxial gyro sensor 233 detects each of a roll rate ωₓ which is an angular velocity around the X axis, a pitch rate ω_{y} which is an angular velocity around the Y axis, and a yaw rate ω_{z} which is an angular velocity around the Z axis. The triaxial gyro sensor 233 can supply detected angular velocity data to the advancing direction calculation unit 139.

The advancing direction calculation unit 139 has a function of calculating an advancing direction θ based on a vibrating direction of the acceleration and geomagnetism during walking. In this case, a detection value of the triaxial geomagnetic sensor 229 includes an error caused by a magnetic field environment. Accordingly, the advancing direction calculation unit 139 can appropriately correct the geomagnetism data detected by the triaxial geomagnetic sensor 229 with use of the angular velocity data detected by the triaxial gyro sensor 233, as necessary.

The walking velocity calculation unit 140 has a function of calculating a moving distance by multiplication of the number of steps and a stride and calculating a walking velocity V based on the moving distance and time taken for movement. The walking velocity calculation unit 140 can supply the calculated walking velocity V to the relative position calculation unit 142.

The relative position calculation unit 142 has a function of calculating an amount of change from a previously calculated position to a current position based on the velocity V calculated by the walking velocity calculation unit 140 and the advancing direction θ calculated by the advancing direction calculation unit 139. The relative position calculation unit 142 can supply information on the relative position calculated herein to the position information generation unit 145.

The atmospheric pressure sensor 235 is a sensor having a function of detecting a surrounding pressure as a voltage value. For example, the atmospheric pressure sensor 235 detects a pressure at a sampling frequency of 1 Hz and supplies the detected pressure data to the altitude calculation unit 144.

The altitude calculation unit 144 can calculate a current altitude of the terminal apparatus 100 based on the pressure data inputted from the atmospheric pressure sensor 235, and supply the calculated altitude data to the position information generation unit 145.

The position information generation unit 145 has a function of generating current position information of the terminal apparatus 100 based on absolute position information by GPS positioning supplied from the GPS processing unit 223, an advancing direction of the user supplied from the advancing direction calculation unit 139, relative position information supplied from the relative position calculation unit 142, and altitude data supplied from the altitude calculation unit 144. For example, when absolute position information is supplied from the GPS processing unit 223, the position information generation unit 145 may use the absolute position information as the current position information. When absolute position information is not supplied from the GPS processing unit 223, the position information generation unit 145 may use the position information based on the relative position supplied from position calculation unit 142 as the current position information. Or alternatively, the position information generation unit 145 may use the absolute position information in suitable combination with the relative position information. Moreover, the position information generated by the position information generation unit 145 may include advancing direction and altitude data of the user.

Examples of the function of the terminal apparatus 100a have hitherto been described with reference to FIGS. 4 and 5. The above-described respective constituent elements may be configured using general units or circuits or may be configured by hardware specialized for the functions of the respective constituent elements. Further, the functions of the respective constituent elements may be performed by reading a control program, which describes a processing order in which the functions are realized by an arithmetic device such as a central processing unit (CPU), from a storage medium such as a read-only memory (ROM) or a random access memory (RAM), which stores the control program, analyzing the control program, and executing the control program. Accordingly, a configuration to be appropriately used may be modified in accordance with a technical level at which this embodiment is realized.

A computer program configured to realize the functions of the terminal apparatus 100a according to the above-described embodiment may be created and mounted on a personal computer or the like. Further, a computer readable recording medium that stores the computer program may be provided. Examples of the recording medium include a magnetic disk, an optical disc, a magneto-optical disc, and a flash memory. Furthermore, the computer program may be delivered via a network or the like without use of a recording medium.

### 2-2. Hardware Configuration Example

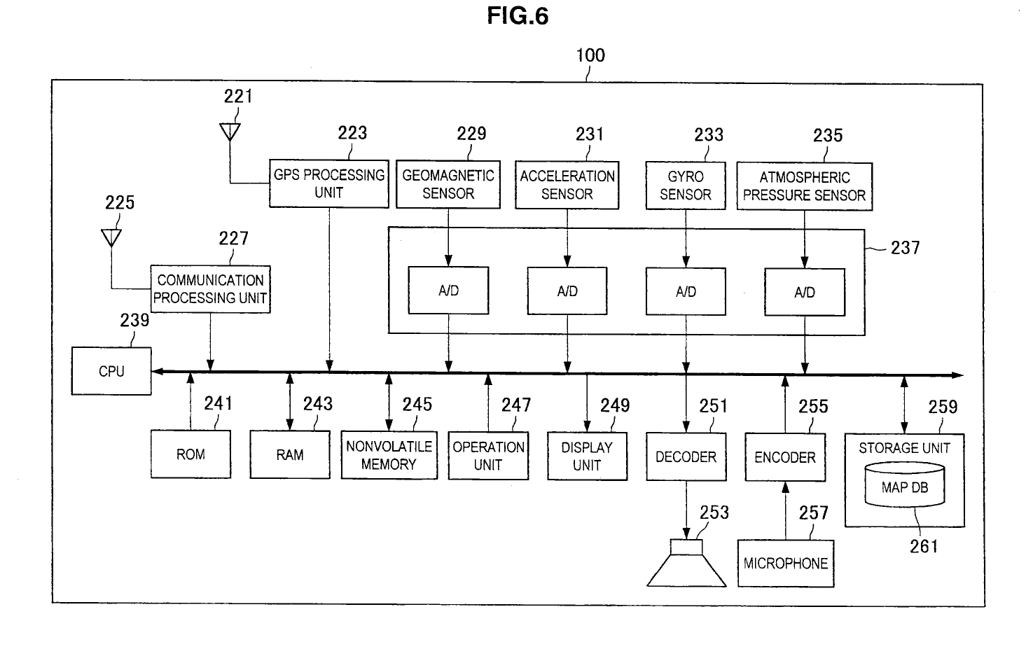

In the terminal apparatus 100a described above according to the first embodiment of the present disclosure, a configuration to be appropriately used may be selected in accordance with a technical level at which this embodiment is realized described above. Here, description will be given of an example of a hardware construction configured to realize the functions of the terminal apparatus 100a with reference to FIG. 6. FIG. 6 is a hardware construction diagram of the terminal apparatus according to the first to third embodiments of the present disclosure. Here, the hardware construction described here is an example, and a part of the constituent elements can be omitted and added. Further, the configuration described here may also be applied to a terminal apparatus 100b according to the second embodiment and a terminal apparatus 100c according to the third embodiment. Therefore, description thereof will be given as the configuration of the terminal apparatus 100.

For example, the terminal apparatus 100 includes a GPS antenna 221, a GPS processing unit 223, a communication antenna 225, a communication processing unit 227, a geomagnetic sensor 229, an acceleration sensor 231, a gyro sensor 233, an atmospheric pressure sensor 235, an A/D(Analog/Digital) conversion unit 237, a central processing unit (CPU) 239, a read-only memory (ROM) 241, a random access memory (RAM) 243, an operation unit 247, a display unit 249, a decoder 251, a speaker 253, an encoder 255, a microphone 257, and a storage unit 259.

The GPS antenna 221 is an example of an antenna that receives signals from positioning satellites. The GPS antenna 221 can receive GPS signals from a plurality of GPS satellites and input the received GPS signal into the GPS processing unit 223.

The GPS processing unit 223 is an example of a calculating unit that calculates position information based on the signals received from the positioning satellites. The GPS processing unit 223 calculates the current position information based on the plurality of GPS signals input from the GPS antenna 221 and outputs the calculated position information. Specifically, the GPS processing unit 223 calculates the position of each GPS satellite based on trajectory data of the UPS satellite and calculates the distance between each GPS satellite and the terminal apparatus 100 based on a time difference between transmission and reception times of the GPS signal. Then, the current three-dimensional position can be calculated based on the calculated position of each GPS satellite and the distance between each GPS satellite and the terminal apparatus 100. Further, the trajectory data of the GPS satellite used here may be included in, for example, the GPS signal. Furthermore, the trajectory data of the GPS satellite may be acquired from an external server via the communication antenna 225.

The communication antenna 225 is an antenna that has a function of receiving a communication signal via, for example, a portable communication network or a wireless local area network (LAN) communication network. The communication antenna 225 can supply the received signal to the communication processing unit 227.

The communication processing unit 227 has a function of performing various kinds of signal processing on the signal supplied from the communication antenna 225. The communication processing unit 227 can supply a digital signal generated from the supplied analog signal to the CPU 239.

The triaxial geomagnetic sensor 229 is a sensor that detects geomagnetism as a voltage value. The geomagnetic sensor 229 may be a triaxial geomagnetic sensor which detects geomagnetism in each of the X, Y and X axis directions. For example, the X axis may herein be defined as a longitudinal direction of a display screen of the terminal apparatus 100, the Y axis as a shorter side direction of the display screen, and the Z axis as a direction orthogonal to the X axis and the Y axis. The geomagnetic sensor 229 supplies the detected geomagnetism data to the A/D conversion unit 237.

The acceleration sensor 231 is a sensor that detects acceleration as a voltage value. The acceleration sensor 231 may be a triaxial acceleration sensor that detects each of the accelerations in the X, Y, and Z axis directions. The acceleration sensor 231 can supply the detected acceleration data to the A/D conversion unit 237.

The gyro sensor 233 may be a kind of a measuring device that detects an angle or an angular velocity of an object. The gyro sensor 233 may preferably be a triaxial gyro sensor that detects a change angle (angular velocity) of a rotation angle as a voltage value around the X, Y, and Z axes. The gyro sensor 833 can supply the detected angular velocity data to the A/D conversion unit 237.

The atmospheric pressure sensor 235 is a sensor that detects a surrounding pressure as a voltage value. The atmospheric pressure sensor 235 can detect a pressure at a predetermined sampling frequency and supply the detected pressure data to the A/D conversion unit 237.

The A/D conversion unit 237 has a function of converting an inputted analog signal to a digital signal and outputting the digital signal. For example, the A/D conversion unit 237 is a conversion circuit that converts an analog signal into a digital signal. It is to be noted that the A/D conversion unit 237 may be built in each sensor.

The CPU 239 functions as an arithmetic device and a control device to control all of the operating processes in the terminal apparatus 100 in accordance with various kinds of programs. The CPU 239 may be a microprocessor. The CPU 239 can realize various functions in accordance with various kinds of programs. For example, the CPU 239 may function as a direction calculation unit that detects an attitude angle based on the acceleration data detected by the acceleration sensor 231 and calculates a direction by using the attitude angle and the geomagnetism data detected by the geomagnetic sensor 229. The CPU 239 may function as a velocity calculation unit that calculates a moving velocity of the terminal apparatus 100 based on the acceleration data detected by the acceleration sensor 231 and the angular velocity data detected by the gyro sensor 233. The CPU 239 may also function as an altitude calculation unit that calculates altitude of the current position based on pressure data detected by the atmospheric pressure sensor 235.

The ROM 241 can store programs, calculation parameters, or the like used by the CPU 239. The RAM 243 can temporarily store programs used in execution of the CPU 239, or parameters or the like appropriately changed in the execution.

The operation unit 247 has a function of generating an input signal used for a user to perform a desired operation. The operation unit 247 may include an input unit, such as a touch panel, a mouse, a keyboard, a button, a microphone, a switch, or a lever, with which a user inputs information and an input control circuit configured to generate an input signal based on the input of the user and output the input signal to the CPU 239.

The display unit 249 is an example of an output device and may be a display device such as a liquid crystal display (LCD) device or an organic light emitting diode (OLED) display device. The display unit 249 can supply information by displaying a screen for a user.

The decoder 251 has a function of performing decoding, analog conversion, or the like on input data under the control of the CPU 239. The decoder 251 performs the decoding, the analog conversion, and the like on audio data input via, for example, the communication antenna 225 and the communication processing unit 227 and outputs an audio signal to the speaker 253. The speaker 253 can output audio based on the audio signal supplied from the decoder 251.

The encoder 255 has a function of performing digital conversion, encoding, or the like on input data under the control of the CPU 239. The encoder 255 can perform the digital conversion, the encoding, and the like on an audio signal input from the microphone 257 and output the audio data. The microphone 257 can collect audio and output the audio as an audio signal.

The storage unit 259 is a data storage device and may include a storage medium, a recording device that records data in a storage medium, a reading device that reads data from a storage medium, and a deleting device that deletes data recorded in a storage medium. Here, for example, a non-volatile memory such as a flash memory, a magnetoresistive random access memory (MRAM), a ferroelectric random access memory (FeRAM), a phase change random access memory (PRAM), or an electronically erasable and programmable read-only memory (EEPROM), or a magnetic recording medium such as a hard disk drive (HDD) may be used as the storage medium. For example, the storage unit 259 can store a map DB 261 and the like. The map DB 263 may include various kinds of information associated with position information, such as point of interest (POI) information, altitude information, and traffic information. It is to be noted that the map DB 263 is included in the terminal apparatus 100 in this case, though the present technology is not limited to the example disclosed. The map DB 261 may be included in an external device. The terminal apparatus 100 may be configured to be able to acquire various kinds of information associated with the position information by appropriately accessing to the map DB 261 included in an external device. The Map DB 261 may also be configured to appropriately acquire map information around the current position from an external device, as necessary.

### 2-3. Oscillation Detection Data

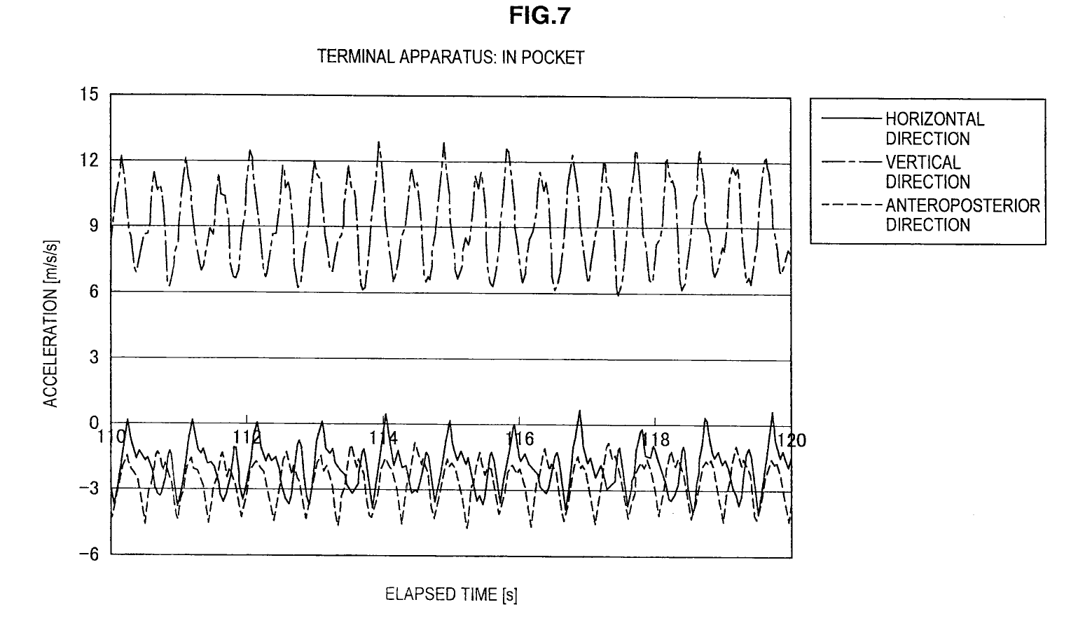

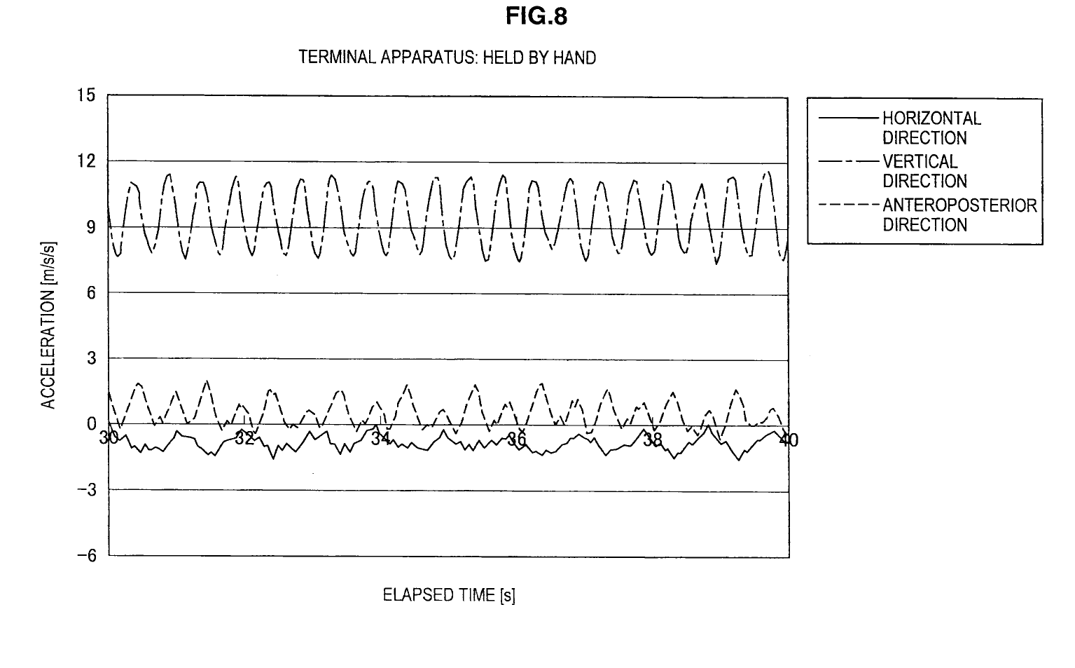

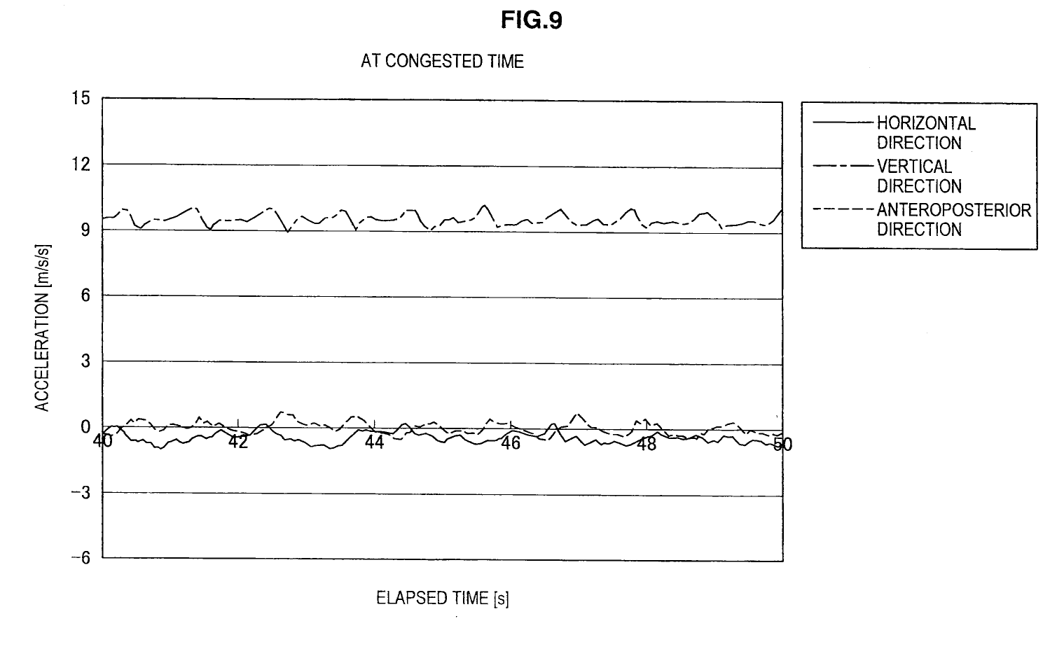

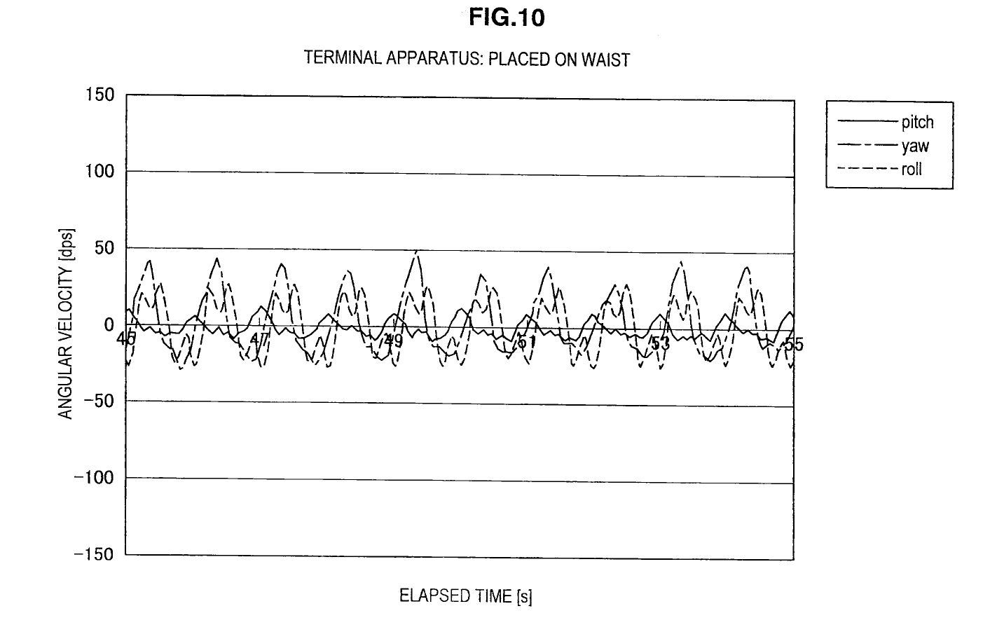

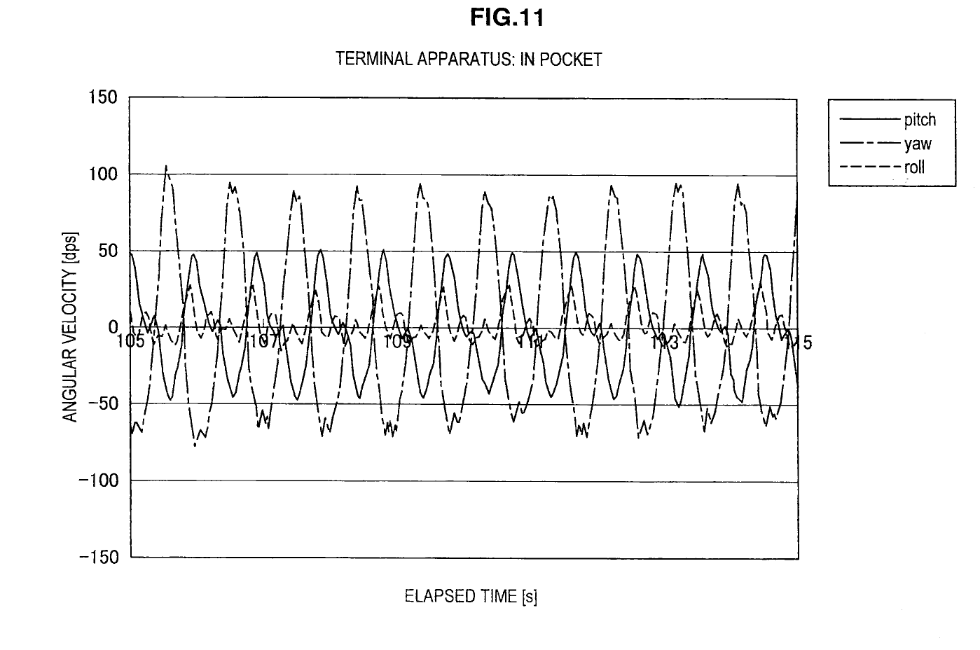

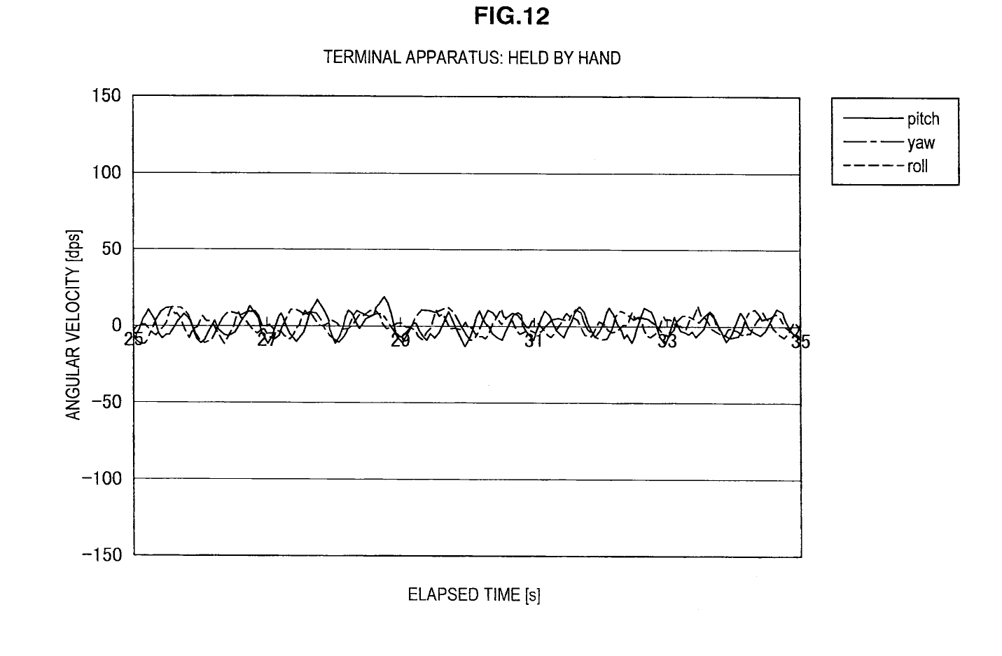

A consideration is now given to the detail of oscillation detection data supplied from the oscillation detector 101 with reference to FIGS. 7 to 11. FIG. 7 is a graph view showing an example of oscillation detection data (detected by an acceleration sensor) at a normal time when the terminal apparatus is put in a pocket and carried around. FIG. 8 is a graph view showing an example of oscillation detection data (detected by an acceleration sensor) at a normal time when the terminal apparatus is held by hand and carried around. FIG. 9 is a graph view showing an example of oscillation detection data (detected by an acceleration sensor) at a congested time. FIG. 10 is a graph view showing an example of oscillation detection data (detected by a gyro sensor) at a normal time when the terminal apparatus is placed on the waist. FIG. 11 is a graph view showing an example of oscillation detection data (detected by a gyro sensor) at a normal time when the terminal apparatus is put in a pocket and carried around. FIG. 12 is a graph view showing an example of oscillation detection data (detected by a gyro sensor) at a normal time when the terminal apparatus is held by hand and carried around.

FIGS. 7 to 9 respectively show oscillation detection data detected with use of an acceleration sensor in the case where the terminal apparatus 100 is put in a pocket and carried around, in the case where the terminal apparatus 100 is held by hand and carried around, and in the case of a congested time. In this regard, among the case where the terminal apparatus 100 is put in a pocket and carried around and the case where the terminal apparatus 100 is held by hand and carried around, amplitude of oscillation detection data is larger in the case where the terminal apparatus 100 is put in a pocket and carried around. However, with reference to FIG. 9, a difference between the amplitude of oscillation detection data of FIG. 7 and the amplitude of oscillation detection data of FIG. 9 and a difference between the amplitude of oscillation detection data of FIG. 8 and the amplitude of oscillation detection data of FIG. 9 are larger than a difference between the amplitude of oscillation detection data of FIG. 7, and the amplitude of oscillation detection data of FIG. 8. Therefore, in this case, the oscillation detection data can be used for state determination regardless of how the terminal apparatus 100 is carried around.

With reference to FIGS. 7 to 9, the oscillation detection data detected by an acceleration sensor, and vertical (vertical-direction) oscillation detection data in particular, arc less likely to be influenced by how the terminal apparatus 100 is carried around. Moreover, since an influence of a walking pitch of the user is more likely to be reflected on the vertical oscillation detection data, it is desirable that the congestion determination unit 107 determines the congestion state based on amplitude and pitch values of the vertical oscillation detection data.

Further, FIGS. 10 to 12 respectively show oscillation detection data detected with use of a gyro sensor in the case where the terminal apparatus 100 is placed on the waist, in the case where the terminal apparatus 100 is put in a pocket and carries around, and in the case where the terminal apparatus 100 is held by hand and carried around. In FIGS. 10 to 12, the amplitude of the oscillation detection data detected with use of a gyro sensor is largely varied depending on how the terminal apparatus 100 is carried around. Accordingly, when the congestion determination unit 107 performs determination of congestion based on the oscillation detection data detected with use of a gyro sensor, it is desirable to perform the determination of congestion by using not the amplitude but the pitch of oscillation detection data. Moreover, among the oscillation detection data detected with use of a gyro sensor, oscillation detection data indicating a yaw angle is less likely to be influenced by how the terminal apparatus 100 is held and an influence of the walking pitch of the user is more likely to be reflected thereon (one cycle for two steps). Accordingly, it is preferable that the congestion determination unit 107 implements the determination of congestion based on a pitch value of the oscillation detection data that indicates a yaw angle.

Moreover, the oscillation detection data used for determination may be detected by an atmospheric pressure sensor. At present, the resolution and sampling period of the atmospheric pressure sensor are still not sufficient enough to measure the walking pitch. However, by using an atmospheric pressure sensor which has a performance high enough to detect vertical movement generated by walking, it becomes possible to use oscillation detection data detected by the atmospheric pressure sensor for determination.

It is to be noted that only a bandwidth (for example, 1.5 to 3.5 Hz) for use in detecting the walking pitch is preferably extracted by using a filter so as to remove noise included in the oscillation detection data acquired with use of the atmospheric pressure sensor. For example, the pressure is largely varied by simple actions such as passing by a vehicle and opening and closing of a window. Accordingly, processing of removing such a noise component becomes important.

### 2-4. Operating Process Example

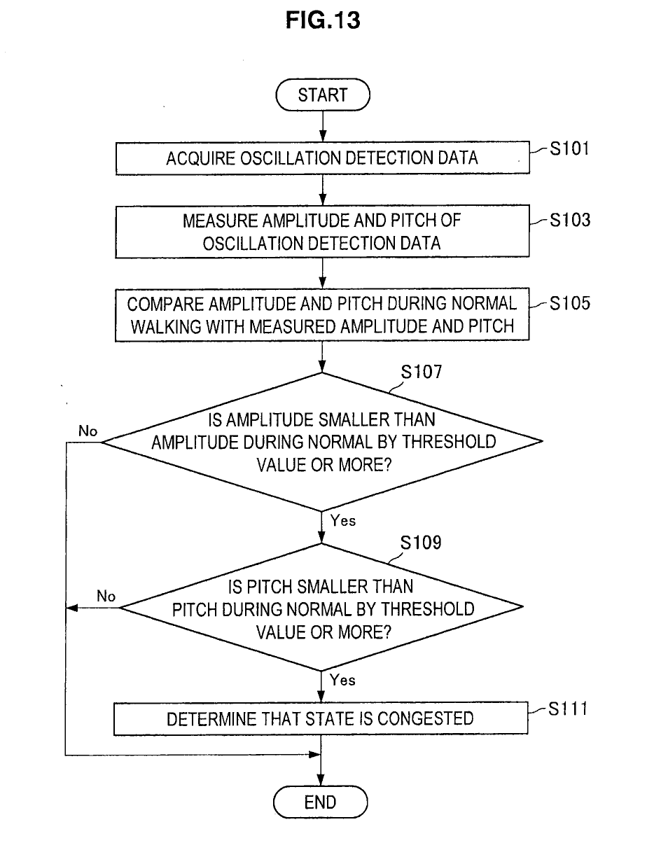

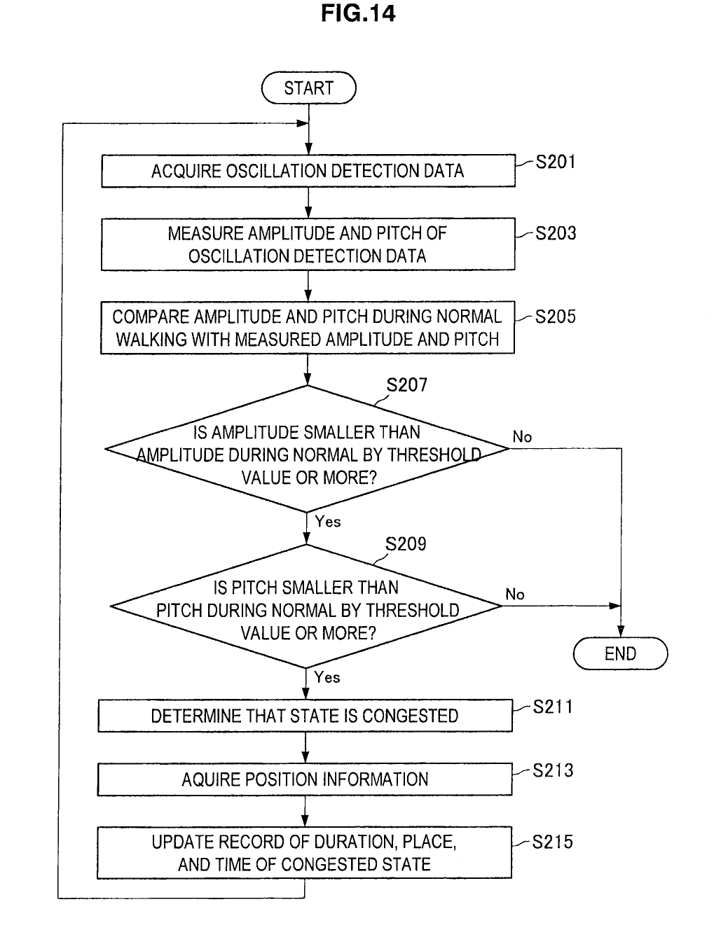

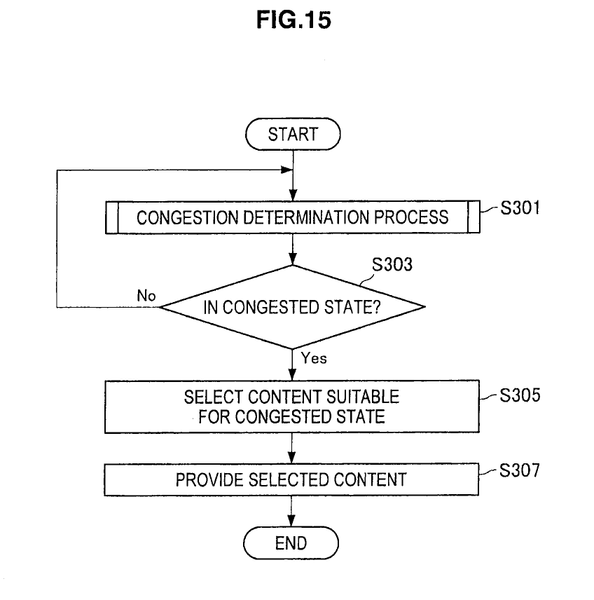

Next, description will be given of an operating process example of the terminal apparatus 100a according to the first embodiment of the present disclosure with reference to FIG. 13 to FIG. 15. FIG. 13 is a flowchart showing an example of a congestion determination process according to an embodiment of the present disclosure. FIG. 14 is a flowchart showing another example of the congestion determination process according to the same embodiment. FIG. 15 is a flowchart showing an operating process of the terminal apparatus according to the first embodiment of the present disclosure.

Here, two congestion determination processes are described. In the congestion determination process shown in FIG. 13, the determination result is only utilized when providing the content as described later and is not stored. Further, in the congestion determination process shown in FIG. 14, the determination result is stored together with the position information.

First, referring to FIG. 13, the oscillation detector 101 acquires the oscillation detection data (S101). Then, the oscillation detector 101 supplies the acquired oscillation detection data to the measuring unit 103. The measuring unit 103 measures amplitude and pitch of the supplied oscillation detection data (S103). The measuring unit 103 supplies the amplitude and pitch of the oscillation detection data obtained by the measurement to the congestion determination unit 107. The congestion determination unit 107 compares the values of the current amplitude and pitch supplied from the measuring unit 103 with the values of the amplitude and pitch during normal walking acquired from the normal walking learning unit 105 (S105).

Then, the congestion determination unit 107 determines whether or not the amplitude of the value supplied from the measuring unit 103 is smaller than amplitude at normal time by a threshold or more (S107). If the amplitude is smaller than that at the normal time by the threshold or more, the congestion determination unit 107 next determines whether or not the pitch of the value supplied from measuring unit 103 is smaller than a pitch at normal time by a threshold or more (S109). If the pitch is determined to be smaller than that at normal time by the threshold or more, the congestion determination unit 107 determines that the state is contested (S111).

For example, the congestion determination unit 107 determined a congestion degree by determining whether or not the apparatus is in the congested state by using a threshold value. However, the present technology is not limited to the example disclosed. For example, pitch and amplitude at a normal time may be compared with pitch and amplitude at the current time, and the congestion degree may be determined in stages depending on a value of the difference or with a continuous value. The congestion determination unit 107 may also store an oscillation at a normal time as two-dimensional distribution of amplitude and pitch (for example, mean value and variance), and to stochastically determine the congestion degree depending on how much a the current oscillation is deviated from distribution at a normal time.

Next, referring to FIG. 14, another example of this congestion determination process is described. First, the oscillation detector 101 acquires the oscillation detection data (S201). Then, the oscillation detector 101 supplies the acquired oscillation detection data to the measuring unit 103. The measuring unit 103 measures amplitude and pitch of the supplied oscillation detection data (S203). The measuring unit 103 supplies the amplitude and pitch of the oscillation detection data obtained by the measurement to the congestion determination unit 107. The congestion determination unit 107 compares the values of the current amplitude and pitch supplied from the measuring unit 103 with the values of the amplitude and pitch during normal walking acquired from the normal walking learning unit 105 (S205).

Subsequently, the congestion determination unit 107 determines whether or not the amplitude of the value supplied from the measuring unit 103 is smaller than amplitude at normal time by a threshold or more (S207). If the amplitude is smaller than that at normal time by the threshold or more, the congestion determination unit 107 determines whether or not the pitch of the value supplied from the measuring unit 103 is smaller than a pitch at normal time by a threshold or more (S209). If the pitch is determined to be smaller than that at normal time by the threshold or more, the congestion determination unit 107 determines that the state is congested (S211).

The congestion determination unit 107, if determining the user of the terminal apparatus 100a is in the congestion state, causes the position information acquisition unit 115 to acquire the current position information (S213). Then, the congestion determination unit 107 updates a record of a place determined to be in the congestion state and a time thereof (S215). At this time, the congestion determination unit 107 may calculate and record a duration of a state determined to be the congestion state.

The terminal apparatus 100a may operate according to the flowchart shown in FIG. 15 by use of a result from the congestion determination processes show in FIG. 13 and FIG. 14. Specifically, the congestion determination process at step S301 may be the congestion determination process shown in FIG. 13, or may be the congestion determination process shown in FIG. 14. When the congestion degree determination process (S301) is performed, the content providing unit 113 determines whether or not the determination result is the congestion state (S303). If the state is determined to be congested, the content providing unit 113 selects the content suitable to the congestion state (S305). The content providing unit 113 provides the selected content (S307).

Here, selection of content at step S305 is described in detail. The content providing unit 113 may select the content for reducing the stress on the user when the user is determined to be in the congestion state, for example. The content for reducing the stress on the user may be, for example, a music content or video content which are thought to be effective to relieve the stress in a melody analysis or a video analysis. At this time, various algorithms for determining a content attribute may be used for the selection of content.

In addition, when the state is congested, the user is considered to be likely to be more interested in the content provided by the terminal apparatus 100 compared to when walking at a normal pace. For this reason, the content providing unit 113 may, when the state is determined to be congested, provide the content in a manner of the push notification. Further, the content providing unit 113 may change the frequency of providing the content in a manner of this push notification depending on the congestion state. The content providing unit 113 can, when the state is congested, provide the content at the frequency higher than that at normal time.

Here, the content suitable to the congestion state is selected only when the state is determined to be congested, but, this technology is not limited to such examples. For example, the content may be selected in response to the determination result also when the state is determined to be not congested.

### 2-5. Example of Effect

The terminal apparatus 100a according the first embodiment has been described above. According to such a configuration, on the basis of the oscillation detection data acquired by the terminal apparatus 100a the user owns, the congestion state of the individual user can be determined at least by comparing the pitch of walking with that during normal walking. At this time, by detecting a pitch of walking from the oscillation detection data, it can be detected that the user is walking and that the pace thereof is decreased. For example, in a method that merely detects a velocity is decreased, the state might be wrongly determined to be congested even when the velocity is decreased in a state of being on the moving walkway or the escalator. However, the terminal apparatus 100a according to this embodiment, when the velocity is decreased during riding on a vehicle, the state is not determined to be congested, and the congestion state during walking can be accurately determined.

At this time, the terminal apparatus 100a carries out the congestion determination based on the difference from during normal walking. If the congestion determination is carried out simply depending on the velocity change, an elder who slowly walks on a routine basis might be typically determined to be in the congestion state. However, the terminal apparatus 100a determines on the basis of the difference from during normal walking so that the accuracy of the congestion determination is improved.

Further, the use of the amplitude of the oscillation detection data for the congestion determination allows the accuracy of the congestion determination to be improved. For example, a tall person may take short steps in order to slowly proceed. At this time, as the step becomes shorter, an up-and-down motion of a body becomes smaller, thus, the amplitude of the oscillation detection data to be detected becomes smaller. This variation of the step is used for the congestion determination to improve the accuracy of the congestion determination.

According to this congestion determination, as described above, the congestion determination during walking can be accurately carried out. For this reason, the congestion determination result is effectively used to select content to be provided or a timing for providing content to the user. For example, even if the content providing unit 113 of the terminal apparatus 100a carries out the push notification, the user is likely not to notice it during normal walking. However, at congested time, since the user is moving at lower velocity as well as proceeds in concert with movement around, the user is much more likely to be able to afford to take a look at a screen of the terminal apparatus 100a. Accordingly, if the push notification is carried out in the congestion state, the user is more likely to be interested in the content notified compared with the push notification carried out during normal walking.

### 3. Second Embodiment

### Example of Uploading Congestion Information to Sever

### 3-1. System Configuration Example

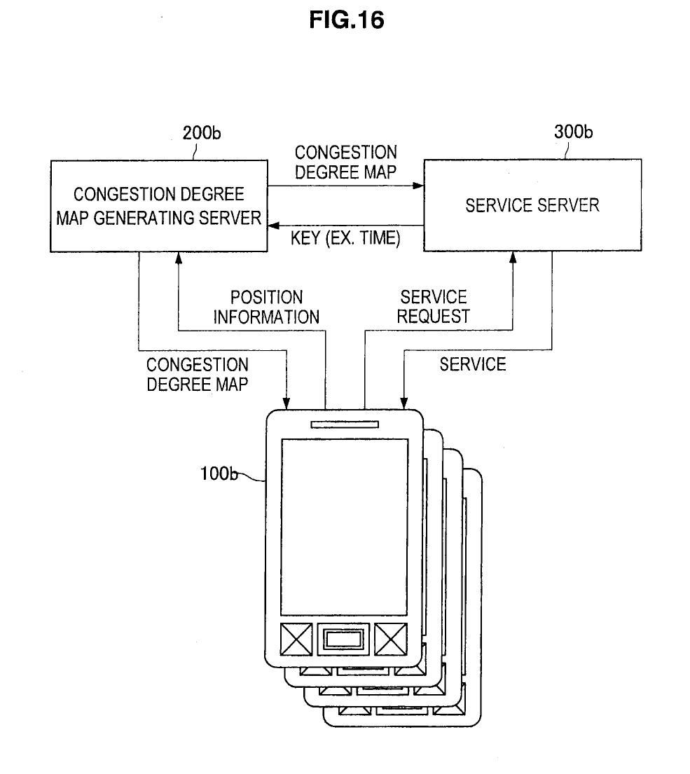

Next, description will be given of a configuration example of a congestion information generating system according to the second embodiment of the present disclosure with reference to FIG. 16. FIG. 16 is a configuration diagram of the congestion information generating system according to the second embodiment of the present disclosure.

A congestion information generating system 1 mainly includes the terminal apparatus 100b, a congestion degree map generating server 200b, and a service server 300b. The congestion degree map generating server 200b and the service server 300b are separate bodies of servers, but the present technology is not limited to such an example. For example, the congestion degree map generating server 200b and the service server 300b may be configured to be integrated into one sever.

The terminal apparatus 100b, which is an example of the congestion state determination apparatus, determines the congestion degree from the oscillation detection data, and acquires the current position information to upload the position information to the congestion degree map generating server 200b when the state is determined to be congested. In addition, the terminal apparatus 100b can acquire a congestion degree map from the congestion degree map generating server 200b. For example, the congestion degree map may be acquired which indicates the congestion degree of the area surrounding of the current position on the basis of the current position information. Further, the terminal apparatus 100b may acquire information by requesting the service server 300 to provide a service.

The congestion degree map generating server 200b has a function to generate the congestion degree map by way of acquiring the position information of the congestion state from a plurality of the terminal apparatuses 100b. For example, the congestion degree map may have a map superimposed with the positions of the terminal apparatuses 100b in the congestion state. At this time, the congestion degree map generating server 200b may present on the congestion degree map the moving directions, that is, the congestion orientations, of the terminal apparatuses 100b besides the positions of the terminal apparatuses 100b.

The service server 300b is a server generating the information to be provided to the user on the basis of the congestion degree map. For example, the service server 300b can find and provide a route for the user to bypass the congestion based on the congestion degree map. Alternatively, the service server 300b can forecast a length of time before the congestion is eliminated on the basis of a duration of the past congestion state to provide to the terminal apparatus 100b.

### 3-2. Functional Configuration Example of Terminal Apparatus

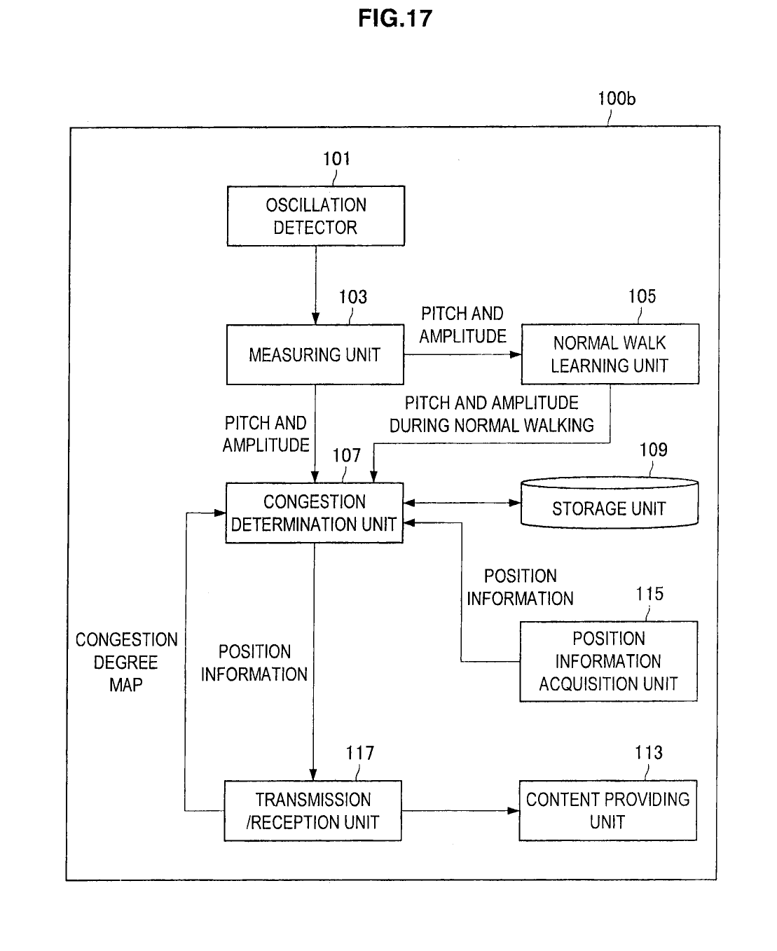

Next, description will be given of a functional configuration example of the terminal apparatus 100b according to the second embodiment of the present disclosure with reference to FIG. 17. FIG. 17 is a functional configuration diagram of the terminal apparatus according to the same embodiment. The terminal apparatus 100b mainly includes the oscillation detector 101, the measuring unit 103, the normal walking learning unit 105, the congestion determination unit 107, the storage unit 109, the content providing unit 113, the position information acquisition unit 115, and a transmission/reception unit 117.

Here, the constituent elements different from those in the terminal apparatus 100a according to the first embodiment are described and portions the same as the terminal apparatus 100a are omitted in the description.

The terminal apparatus 100b can acquire the congestion degree map via the transmission/reception unit 117 from the congestion degree map generating server 200b. The congestion determination unit 107 may adjust the threshold used for the congestion determination based on the acquired information of the congestion degree map. For example, in the case where it is found from the congestion degree map that the terminals surrounding the terminal apparatus 100b are determined to be in the congestion state, the terminal apparatus 100b is highly possibly also in the congestion state. For this reason, when the threshold is barely not exceeded and the surrounding area is in the congestion state, the terminal apparatus 100b desirably adjusts the threshold at that time such that the stated is determined to be congested. Moreover, the content providing unit 113 can provide the content acquired from an external sever to the user via the transmission/reception unit 117. For example, the content providing unit 113 may provide the content acquired from the service server 300b to the user.

Additionally, the congestion determination unit 107, when the stated is determined to be congested, can transmit the current position information via the transmission/reception unit 117 to the congestion degree map generating server 200. Here, the current position information may include the congestion orientation calculated from the advancing direction of the user. At this time, the congestion determination unit 107 may transmit information for identifying the terminal apparatus 100b to the congestion degree map generating server 200.

### 3-3. Operating Process Example

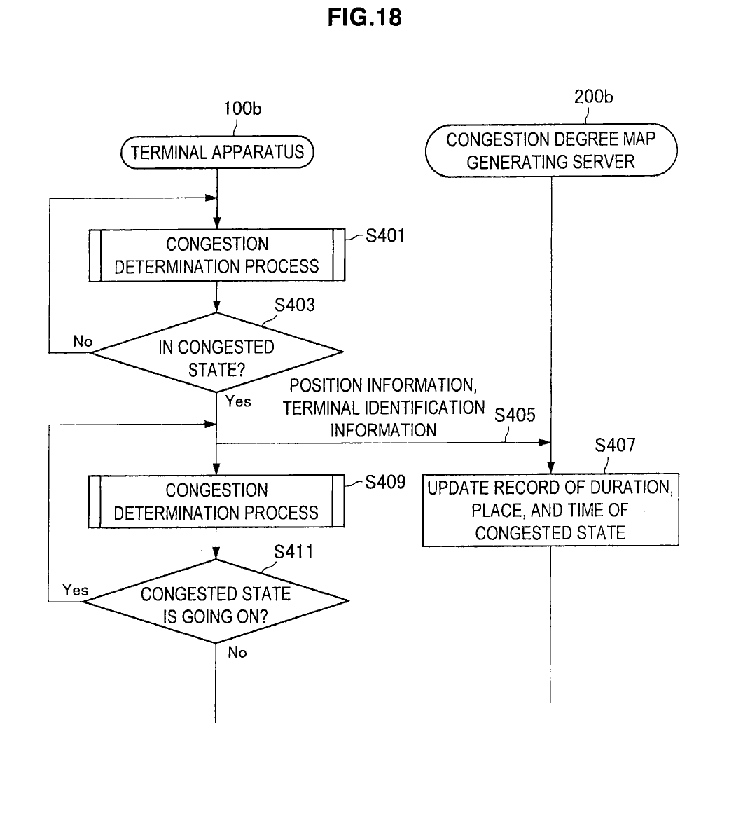

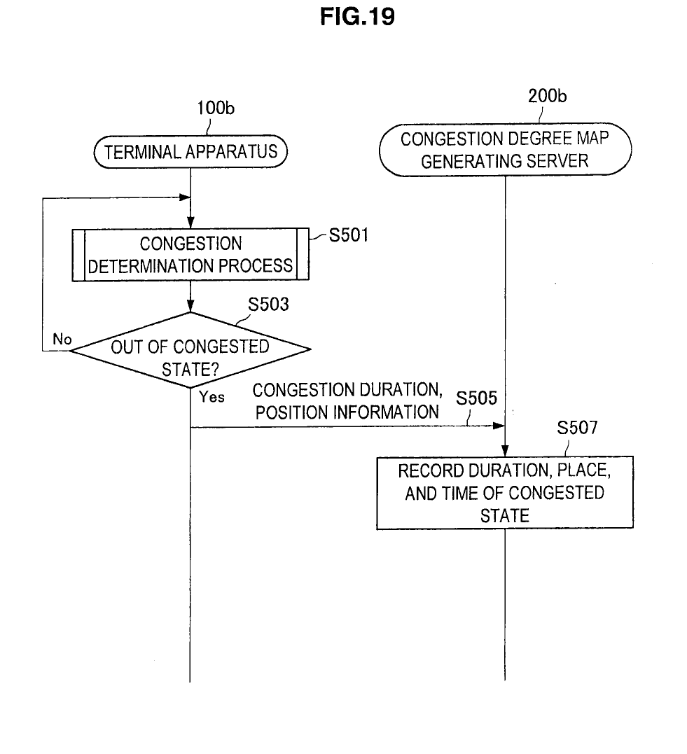

Next, description will be given of an operating process example of the congestion information generating system according to the second embodiment of the present disclosure with reference to FIG. 18 and FIG. 19. FIG. 18 is a sequence diagram showing an example of the operating process of the congestion information generating system according to the same embodiment. FIG. 19 is a sequence diagram showing another example of the operating process of the congestion information generating system according to the same embodiment. Here, the operating process example in FIG. 18 is different from the operating process example in FIG. 19 in a timing at which the terminal apparatus 100b transmits the information concerning the congestion state to the congestion degree map generating server 200b.

Referring to FIG. 18, firstly, the terminal apparatus 100b performs the congestion determination process (S401). Then, the congestion determination unit 107 determines whether or not the state is determined to be congested (S403), and, if the state is determined to be congested, transmits the current position information and the information for identifying the terminal apparatus 100b to the congestion degree map generating server 200b (S405).

Subsequently, the congestion degree map generating server 200b which has received the current position information of the terminal apparatus 100b and the terminal identification information updates the record of the duration, place and time of the congestion state about the relevant terminal apparatus 100b (S407).

On the other hand, the terminal apparatus 100b performs again the congestion determination process (S409). Then, the congestion determination unit 107 determines whether or not the congestion state is going on (S411). If the congestion state is ongoing, the congestion determination unit 107 transmits again the current position information and the information for identifying the terminal apparatus 100b to the congestion degree map generating server 200b. This process from step S405 to step S411 is repeated until the terminal apparatus 100b gets out of the congestion state.

Here, the congestion determination processes at step S401 and step S409 may be the congestion determination process shown in FIG. 13. Alternatively, the congestion determination processes at step S401 and step S409 may be the congestion determination process shown in FIG. 14.

In addition, the congestion information generating system according to this embodiment may operate as is shown in FIG. 19. In this case, the terminal apparatus 100b performs the congestion determination process at first (S501). Here, the congestion determination process at step S501 may be the congestion determination process shown in FIG. 13. Alternatively, the congestion determination process at step S501 may be the congestion determination process shown in FIG. 14.

Then, the congestion determination unit 107 determines whether or not the terminal apparatus 100b gets out of the congestion state (S503). When the terminal apparatus 100b gets out of the congestion state, the congestion determination unit 107 acquires the duration and current position information of the congestion state to transmit to the congestion degree map generating server 200b (S505). The congestion degree map generating server 200b records the duration, place, and time of the congestion state (S507).

### 3-4. Example of Effect

The congestion information generating system according to the second embodiment of the present disclosure has been described above. In this embodiment, the terminal apparatus 100b can transmit the information that the state is congested to the congestion degree map generating server 200b. The congestion degree map is utilized in order to adjust the threshold used for the congestion determination as described above. This allows the accuracy of the congestion determination to be improved. Note that the congestion degree map provided here and an example of the service provided by the service server are common to those of the third embodiment described next, and are described later as an application example.

### 4. Third Embodiment

### Example of Performing Congestion Determination on Sever Side

### 4-1. System Configuration Example

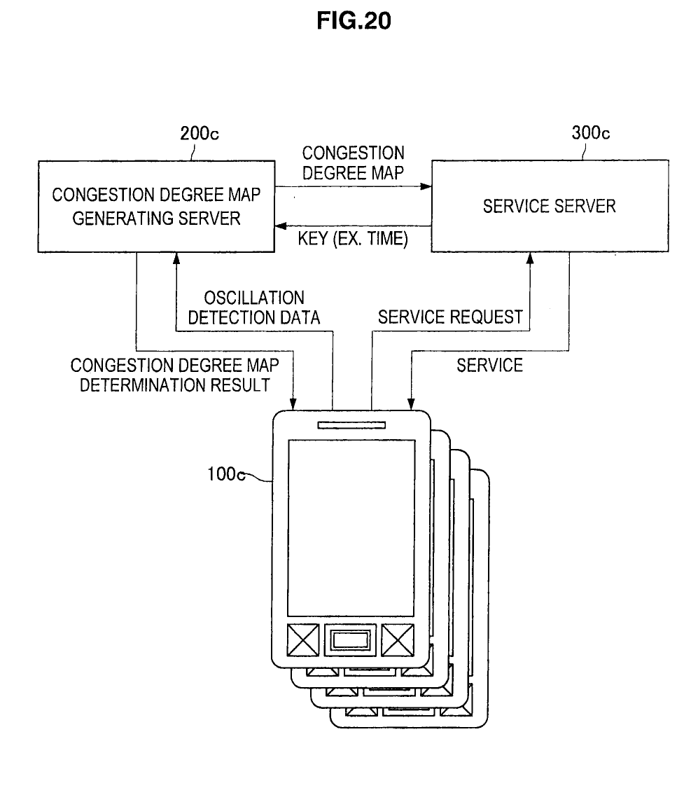

Next, description will be given of a configuration of the congestion information generating system according to the third embodiment of the present disclosure with reference to FIG. 20. FIG. 20 is a configuration diagram of the congestion information generating system according to the third embodiment of the present disclosure.

The congestion information generating system according to this embodiment mainly includes the terminal apparatus 100c, a congestion degree map generating server 200c, and a service server 300c. In the first and second embodiments, the terminal apparatus 100 performs the congestion determination process. In this embodiment, the oscillation detection data acquired by the terminal apparatus 100c is transmitted to the congestion degree map generating server 200c, and the congestion degree map generating server 200c performs the congestion determination process.

### 4-2. Functional Configuration Example

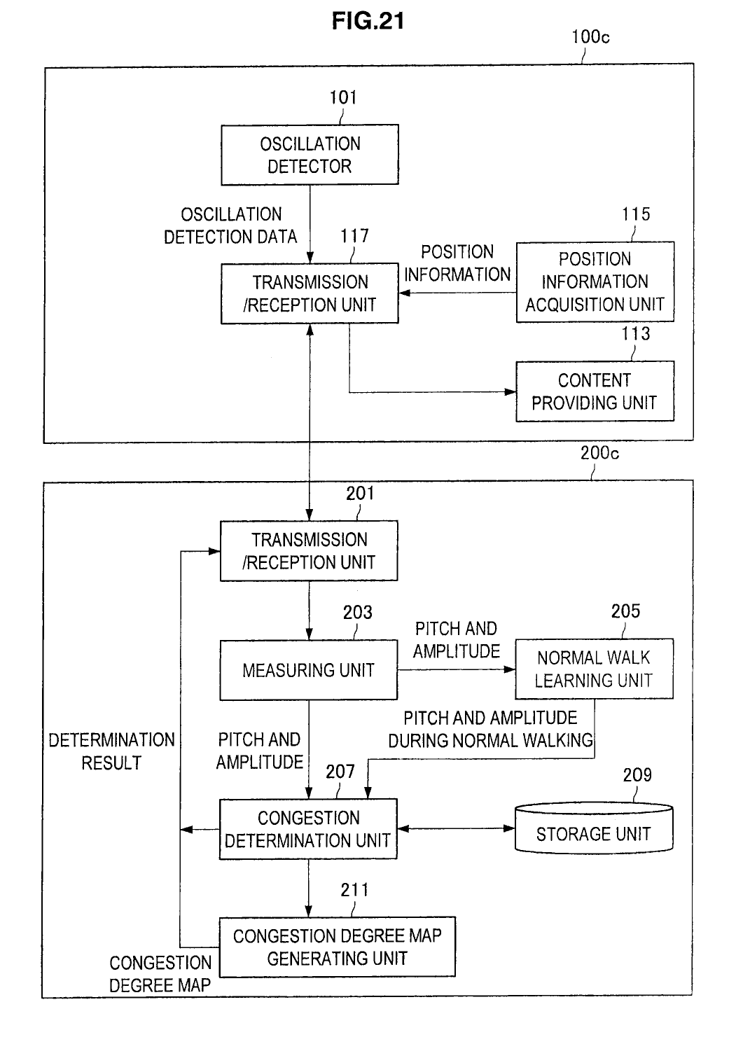

Next, description will be given of the functional configurations of the terminal apparatus 100c and congestion degree map generating server 200c in the congestion information generating system according to this embodiment with reference to FIG. 21. FIG. 21 is a functional configuration diagram of the congestion information generating system according to the same embodiment.

The terminal apparatus 100c mainly includes the oscillation detector 101, the content providing unit 113, the position information acquisition unit 115, and the transmission/reception unit 117. The transmission/reception unit 117 transmits the oscillation detection data detected by the oscillation detector 101 to the congestion degree map generating server 200c.

The congestion degree map generating apparatus 200c mainly includes a transmission/reception unit 201, a measuring unit 203, a normal walking learning unit 205, a congestion determination unit 207, a storage unit 209, and a congestion degree map generating unit 211.

Here, the measuring unit 203 has a function the same as the measuring unit 103. The normal walking learning unit 205 has a function the same as the normal walking learning unit 205. The congestion determination unit 207 has a function the same as the congestion determination unit 107. Moreover, the storage unit 209 has a function the same as the storage unit 109.

However, the congestion degree map generating server 200c stores the information of the congestion states for a plurality of the terminal apparatuses 100c, and thus, the storage unit 209 preferably stores the information of the congestion state together with the information for identifying the terminal apparatus 100c. At this time, the information for identifying the terminal apparatus 100c may not be information to specify the terminal apparatus 100c or the user thereof so long as the information can be identified to concern with the terminal apparatus 100c. With privacy of the user taken into consideration, it may be preferable that the information may not identify the terminal apparatus 100c or the user thereof.

### 4-3. Operating Process Example

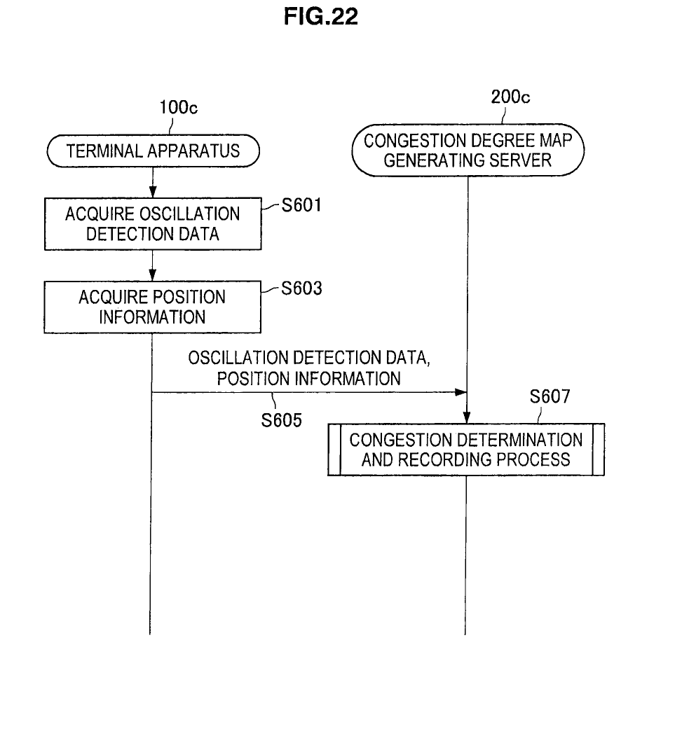

Next, description will be given of an example of an operating process of the congestion information generating system according to this embodiment with reference to FIG. 22. FIG. 22 is a sequence diagram showing an example of the operating process of the congestion information generating system according to the same embodiment.

First, the oscillation detector 101 of the terminal apparatus 100c acquires the oscillation detection data (S601). Then, the position information acquisition unit 115 acquires the current position information of the terminal apparatus 100c (S603). The terminal apparatus 100c transmits the acquired oscillation detection data and position information via the transmission/reception unit 117 to the congestion degree map generating server 200c (S605). The congestion degree map generating server 200c which has acquired the oscillation detection data and the position information carries out a congestion determination and recording process (S607). Here, the congestion determination and recording process at step S607 may be the process shown in FIG. 14, for example.

### 4-4. Example of Effect

As described above, according to the congestion information generating system of this embodiment, the congestion determination process is performed on the server side. For this reason, a processing load on the terminal apparatus 100c is effectively reduced. Specifically, the terminal apparatus 100c having low processing capability can also perform the congestion determination process.

### 5. Application Example

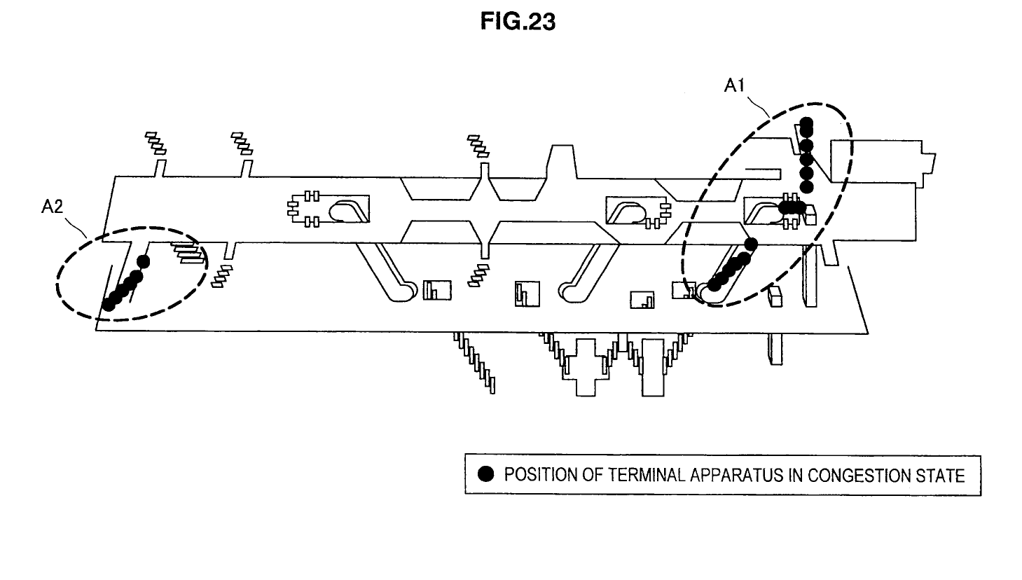

Next, description will be given of an example of a service which can be provided by utilizing the congestion information generating system according to the second and third embodiments of the present disclosure with reference to FIG. 23 to FIG. 28. FIG. 23 to FIG. 28 are illustrations each showing an example of congestion information provided by the congestion information generating system according to the second and third embodiments of the present disclosure.

For example, the congestion degree map generating server 200 may provide the congestion degree map shown in FIG. 23. Here, it is found that congestions occur near an area A1 and an area A2. At this time, the service server 300 may find the route for bypassing the area A1 and the area A2 which are congested to provide to the user of the terminal apparatus 100, in addition to the congestion degree map, for example.

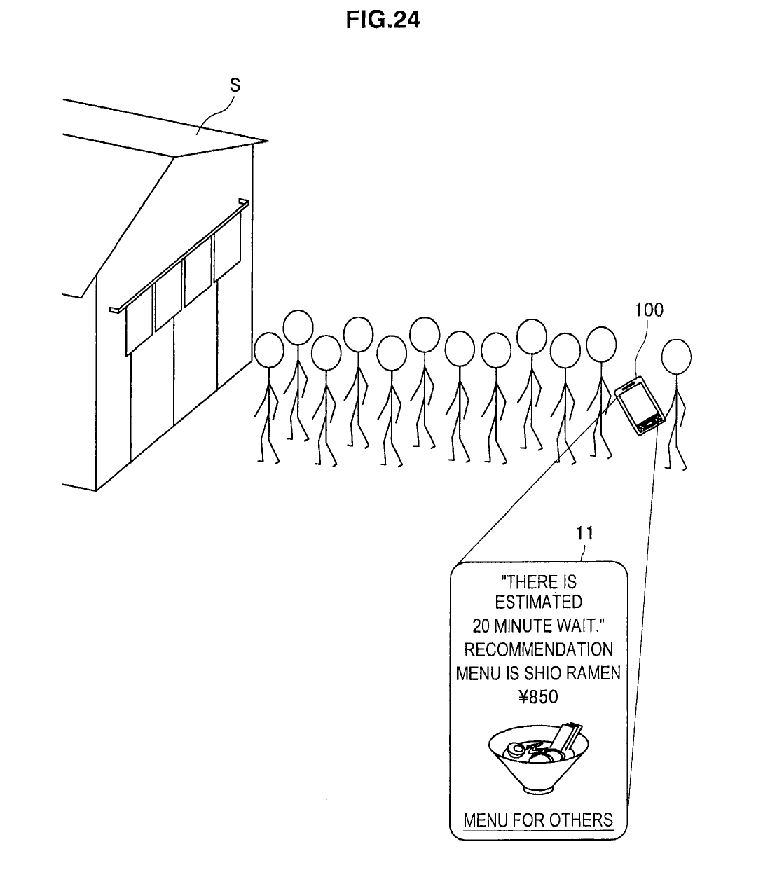

Moreover, as shown in FIG. 24, the service server 300 may provide information of estimated wait time to the terminal apparatus 100 of the user who is waiting in line in a queue generated in front of a shop S. For example, the service server 300 may estimate the wait time from the congestion state duration information which was from the same day of the week in the past in the same time zone at the same position to provide to the user. Additionally, the service server 300 may provide the information of the shop S at the head of the queue to the terminal apparatus 100 of the user. For example, in the case where the shop S is an eating place, the service server 300 may provide menu information to the user. Alternatively, the service server 300 may provide the recommendation menu information to the user.

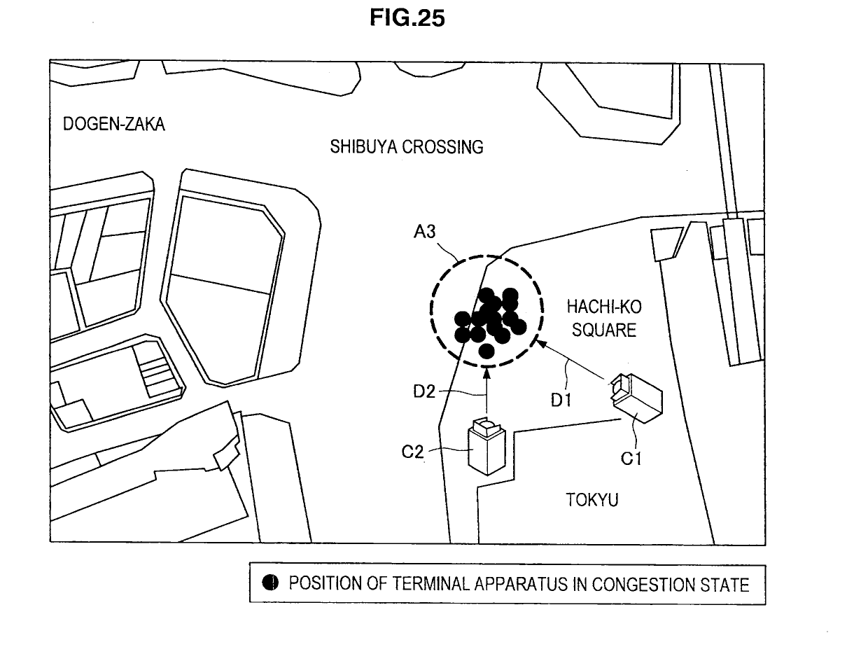

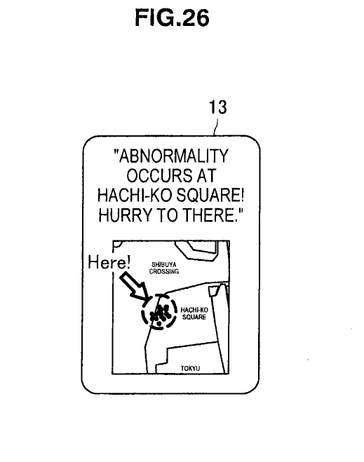

Alternatively, as show in FIG. 25, in the case where the terminal apparatuses 100 determined to be in congestion state are densely packed in a certain area A3, a direction D of a monitoring camera C may be turned in a direction of the area A3. Alternatively, at this time, this congestion information may be used in order to send security guards to the area A3 which is dense with the terminal apparatuses 100 determined to be in the congestion state. For example, as a screen 13 shown in FIG. 26, by displaying a screen indicating on the map an area which is dense with the terminal apparatuses 100 in the congestion state on display units of terminal apparatuses the security guards carry, the security guard can be properly arranged at a place they are desired. For example, an unexpected abnormal event such as a surprise concert can be coped with.

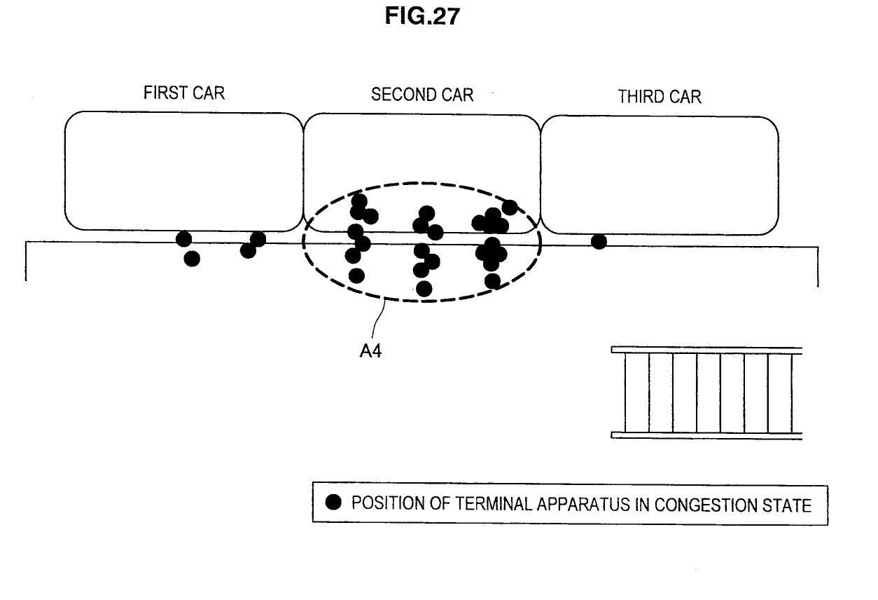

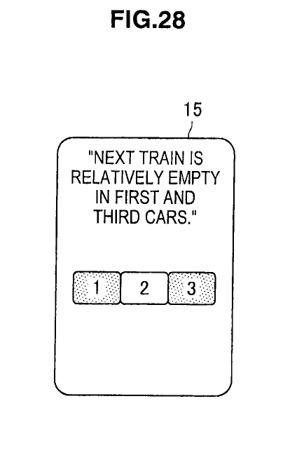

Additionally, as shown in FIG. 27, detections in many numbers that the congestion state occurs in the vicinity of a door in a train when leaving a previous station (area A4) represent that the congestion occurs when the train is boarded and exited because a certain large amount of persons get on the train. For this reason, the service server 300 can specify a vehicle the user of each terminal apparatus 100 to get on from the position of the terminal apparatus 100 in the congestion state. The service server 300 may utilize this congestion information in order to guide the user to the vehicle relatively empty by use of a screen 15 shown in FIG. 28, for example.

As described above, the preferred embodiments of the present disclosure are described in detail with reference to the accompanying drawings, but the present technology is not limited to such examples. It is obvious that a person ordinarily skilled in the art to which the present disclosure pertains can easily conceive various changes or modifications in the scope of the technical idea set forth in the claims, and these changes or modifications are of course to be understood to pertain to the technical scope of the present disclosure.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

For example, in the above embodiments, the congestion determination is carried out on the basis of the values of the pitch and amplitude of the oscillation detection data, but the present technology is not limited to such an example. For example, the congestion determination may be carried out on the basis of only the pitch. At this time, the congestion determination may be carried out on the basis of a difference between a one-dimensional distribution of the pitch during normal walking calculated on the basis of the oscillation detection data of a past and the pitch acquired by the acquisition unit. Further, the congestion determination may be carried out on the basis of a difference amount between the pitch acquired by the acquisition unit and the pitch during normal walking. For example, in the case where the amplitude of the oscillation detection data is not likely to depend on a way to hold the terminal apparatus 100 and likely to be reflected by the effect of the congestion degree, the value of the amplitude is desirably used besides the pitch to carry out the congestion determination.

For example, in the third embodiment, congestion degree map generating server for generating the congestion degree map performs the congestion determination process, but the present technology is not limited to such an example. For example, a separate body of server from the congestion degree map generating server may perform the congestion determination process.

In the specification, the steps described in the flowchart include not only processes performed chronologically in the described order but also processes performed in parallel or separately even when the processes are not necessarily performed chronologically. Of course, the order of the steps processed chronologically may be changed appropriately, as necessary.

Additionally, the present technology may also be configured as below.

(1)

An information processing apparatus including:

an acquisition unit configured to acquire a pitch of walking from oscillation detection data; and

a congestion determination unit configured to determine a congestion degree based on a difference between the pitch acquired by the acquisition unit and a pitch during normal walking which is calculated based on the oscillation detection data of a past.

(2)

The information processing apparatus according to (1), wherein

the congestion determination unit determines the congestion degree based on a difference between a distribution of the pitch during normal walking and the pitch acquired by the acquisition unit.

(3)

The information processing apparatus according to (1), wherein

the congestion determination unit determines the congestion degree based on a difference amount between the pitch acquired by the acquisition unit and the pitch during normal walking.

(4)

The information processing apparatus according to any one of (1) to (3), wherein

the acquisition unit further acquires amplitude of the oscillation detection data, and

the congestion determination unit determines the congestion degree further based on a difference between the amplitude acquired by the acquisition unit and amplitude during normal walking which is calculated based on the oscillation detection data of the past.

(5)

The information processing apparatus according to (4), wherein

the congestion determination unit determines the congestion degree based on a difference between a two-dimensional distribution of the pitch and amplitude during normal walking and the pitch and amplitude acquired by the acquisition unit.

(6)

The information processing apparatus according to (4), wherein

the congestion determination unit determines the congestion degree based on a difference amount between the pitch acquired by the acquisition unit and the pitch during normal walking, and a difference amount between the amplitude acquired by the acquisition unit and the amplitude during normal walking.

(7)

The information processing apparatus according to any one of (1) to (6), wherein

the acquisition unit acquires a pitch of walking from the oscillation detection data in a vertical direction.

(8)

The information processing apparatus according to any one of (1) to (7), wherein

the congestion determination unit determines the congestion degree using a threshold of which value is adjusted on the basis of a congestion degree of a surrounding user.

(9)

The information processing apparatus according to any one of (1) to (8), further including:

a selection unit configured to select content based on the congestion degree determined by the congestion determination unit; and

a content providing unit configured to provide the content selected by the selection unit.

(10)

The information processing apparatus according to (9), wherein

the selection unit changes a frequency of providing the content to the user based on the congestion degree determined by the congestion determination unit.

(11)

The information processing apparatus according to (10), wherein

the selection unit increases the frequency of providing the content to the user when the congestion determination unit determines that a state is congested.

(12)

The information processing apparatus according to (9) or (10), wherein

the selection unit selects content having an effect for reducing a stress on the user when the congestion degree determination unit determines that the congestion degree is high.

(13)

The information processing apparatus according to any one of (9) to (12), further including:

a position information acquisition unit configured to acquire current position information,

wherein the selection unit selects content further based on the current position information.

(14)

The information processing apparatus according to (13), wherein

the selection unit selects content concerning a shop at a head of a queue that the user is waiting in line on the basis of the current position information.

(15)

A congestion degree map generating apparatus including:

an acquisition unit configured to acquire position information of a user who is determined to be in a congestion state based on a difference between a pitch of walking detected from oscillation detection data which is acquired by a plurality of terminal apparatuses and a pitch during normal walking calculated based on the oscillation detection data of a past; and

a congestion degree map generating unit configured to generate a congestion degree map having a map superimposed with the position information acquired by the acquisition unit.

(16)

An information processing method including:

acquiring a pitch of walking from oscillation detection data; and

determining a congestion degree based on a difference between the acquired pitch and a pitch during normal walking which is calculated based on the oscillation detection data of a past.

(17)

A program for causing a computer to function as an information processing apparatus, the information processing apparatus including

an acquisition unit configured to acquire a pitch of walking from oscillation detection data, and

a congestion determination unit configured to determine a congestion degree based on a difference between the pitch acquired by the acquisition unit and a pitch during normal walking which is calculated based on the oscillation detection data of a past.

(18)

A computer readable recording medium having a program recorded thereon, the program causing a computer to function as an information processing apparatus including

an acquisition unit configured to acquire a pitch of walking from oscillation detection data, and

a congestion determination unit configured to determine a congestion degree based on a difference between the pitch acquired by the acquisition unit and a pitch during normal walking which is calculated based on the oscillation detection data of a past.

### REFERENCE SIGNS LIST

100 Terminal apparatus
101 Oscillation detector
103 Measuring unit
105 Normal walking learning unit
107 Congestion determination unit
109 Storage unit
113 Content providing unit
115 Position information acquisition unit
117 Transmission/reception unit
200 Congestion degree map generating server
300 Service server

1. An information processing apparatus comprising:
an acquisition unit configured to acquire a pitch of walking from oscillation detection data; and
a congestion determination unit configured to determine a congestion degree based on a difference between the pitch acquired by the acquisition unit and a pitch during normal walking which is calculated based on the oscillation detection data of a past.

2. The information processing apparatus according to claim 1, wherein
the congestion determination unit determines the congestion degree based on a difference between a distribution of the pitch during normal walking and the pitch acquired by the acquisition unit.

3. The information processing apparatus according to claim 1, wherein
the congestion determination unit determines the congestion degree based on a difference amount between the pitch acquired by the acquisition unit and the pitch during normal walking.

4. The information processing apparatus according to claim 1, wherein
the acquisition unit further acquires amplitude of the oscillation detection data, and
the congestion determination unit determines the congestion degree further based on a difference between the amplitude acquired by the acquisition unit and amplitude during normal walking which is calculated based on the oscillation detection data of the past.

5. The information processing apparatus according to claim 4, wherein
the congestion determination unit determines the congestion degree based on a difference between a two-dimensional distribution of the pitch and amplitude during normal walking and the pitch and amplitude acquired by the acquisition unit.

6. The information processing apparatus according to claim 4, wherein
the congestion determination unit determines the congestion degree based on a difference amount between the pitch acquired by the acquisition unit and the pitch during normal walking, and a difference amount between the amplitude acquired by the acquisition unit and the amplitude during normal walking.

7. The information processing apparatus according to claim 1, wherein
the acquisition unit acquires a pitch of walking from the oscillation detection data in a vertical direction.

8. The information processing apparatus according to claim 1, wherein
the congestion determination unit determines the congestion degree using a threshold of which value is adjusted on the basis of a congestion degree of a surrounding user.

9. The information processing apparatus according to claim 1, further comprising:
a selection unit configured to select content based on the congestion degree determined by the congestion determination unit; and
a content providing unit configured to provide the content selected by the selection unit.

10. The information processing apparatus according to claim 9, wherein
the selection unit changes a frequency of providing the content to the user based on the congestion degree determined by the congestion determination unit.

11. The information processing apparatus according to claim 10, wherein
the selection unit increases the frequency of providing the content to the user when the congestion determination unit determines that a state is congested.

12. The information processing apparatus according to claim 9, wherein
the selection unit selects content having an effect for reducing a stress on the user when the congestion degree determination unit determines that the congestion degree is high.

13. The information processing apparatus according to claim 9, further comprising:
a position information acquisition unit configured to acquire current position information,
wherein the selection unit selects content further based on the current position information.

14. The information processing apparatus according to claim 13, wherein
the selection unit selects content concerning a shop at a head of a queue that the user is waiting in line on the basis of the current position information.

15. A congestion degree map generating apparatus comprising:
an acquisition unit configured to acquire position information of a user who is determined to be in a congestion state based on a difference between a pitch of walking detected from oscillation detection data which is acquired by a plurality of terminal apparatuses and a pitch during normal walking calculated based on the oscillation detection data of a past; and
a congestion degree map generating unit configured to generate a congestion degree map having a map superimposed with the position information acquired by the acquisition unit.

16. An information processing method comprising:
acquiring a pitch of walking from oscillation detection data; and
determining a congestion degree based on a difference between the acquired pitch and a pitch during normal walking which is calculated based on the oscillation detection data of a past.

17. A program for causing a computer to function as an information processing apparatus, the information processing apparatus including
an acquisition unit configured to acquire a pitch of walking from oscillation detection data, and
a congestion determination unit configured to determine a congestion degree based on a difference between the pitch acquired by the acquisition unit and a pitch during normal walking which is calculated based on the oscillation detection data of a past.

18. A computer readable recording medium having a program recorded thereon. the program causing a computer to function as an information processing apparatus including
an acquisition unit configured to acquire a pitch of walking from oscillation detection data, and
a congestion determination unit configured to determine a congestion degree based on a difference between the pitch acquired by the acquisition unit and a pitch during normal walking which is calculated based on the oscillation detection data of a past.
